(19) United States
(12) Patent Application Publication
(10) Pub. No.: US 2003/0074196 A1
(43) Pub. Date: Apr. 17, 2003

(54) Text-to-speech conversion system

(76) Inventor: Hiroki Kamanaka, Tokyo (JP)

Correspondence Address: RABIN & CHAMPAGNE, PC, 1101 14TH STREET, NW, SUITE 500, WASHINGTON, DC, 20005, US

(21) Appl. No.: 09/907,660

(22) Filed: Jul. 19, 2001

(30) Foreign Application Priority Data
Jan. 25, 2001 (JP) 017058/2001

(51) Int. Cl. G10L 13/08

(52) U.S. Cl. 704/260

(57) ABSTRACT

The system according to the invention comprises a text-to-speech conversion processing unit, and a phrase dictionary as well as a waveform dictionary, connected independently from each other to the conversion processing unit. The conversion processing unit is for converting any Japanese text inputted from outside into speech. In the phrase dictionary, sound-related terms representing the actually recorded sounds, for example, notations of terms such as onomatopoeic words, background sounds, lyrics, music titles, and so forth, are previously registered. Further, in the waveform dictionary, waveform data obtained from the actually recorded sounds, corresponding to the sound-related terms, are previously registered. Furthermore, the conversion processing unit is constituted such that as for a term in the text matching the sound-related term registered in the phrase dictionary upon collation of the former with the latter, actually recorded speech waveform data corresponding to the relevant sound-related term matching the term in the text, registered in the waveform dictionary, is outputted as a speech waveform of the term.

### BACKGROUND OF THE INVENTION

1. Field of the Invention

The present invention relates to a text-to-speech conversion system, and in particular, to a Japanese-text to speech conversion system for converting a text in Japanese into a synthesized speech.

2. Description of the Related Art

A Japanese-text to speech conversion system is a system wherein a sentence in both kanji (Chinese character) and kana (Japanese alphabet), which Japanese native speakers daily write and read, is inputted as an input text, the input text is converted into voices, and the voices as converted are outputted as a synthesized speech. FIG. 1 shows a block diagram of a conventional system by way of example. The conventional system is provided with a conversion processing unit 12 for converting a Japanese text inputted through an input unit 10 into a synthesized speech. The Japanese text is inputted to a text analyzer 14 of the conversion processing unit 12. In the text analyzer 14, a phonetic/prosodic symbol string is generated from a sentence in both kanji and kana as inputted. The phonetic/prosodic symbol string represents description (intermediate language) of pronunciation, intonation, etc. of the inputted sentence, expressed in the form of a character string. Pronunciation of each word is previously registered in a pronunciation dictionary 16, and the phonetic/prosodic symbol string is generated by referring to the pronunciation dictionary 16. When, for example, a text reading as “ [symbol] (a cat mewed)” is inputted, the text analyzer 14 divides the input text into words by use of the longest string-matching method as is well known, that is, by use of the longest word with a notation matching the input text while referring to the pronunciation dictionary 16. In this case, the input text is converted into a word string consisting of [symbol] ne' ko)┘, ┌ [symbol] (ga) ┘, [symbol] (nya'-)┘, ┌ [symbol] (nai)┘, and ┌ [symbol] (ta)┘. What is shown in the round brackets is information on each word, registered in the dictionary, that is, pronunciation of the respective words.

The text analyzer 14 generates a phonetic/prosodic symbol string shown as ┌ne' ko ga, nya' -to, naita┘ by use of the information on each word of the word string, registered in the dictionary, that is, the information in the round brackets, and on the basis of such information, speech synthesis is executed by a rule-based speech synthesizer 18. In the phonetic/prosodic symbol string, ┌,┘ indicates the position of an accented syllable, and ┌,┘ indicates a punctuation of phrases.

The rule-based speech synthesizer 18 generates synthesized waveforms on the basis of the phonetic/prosodic symbol string by referring to a memory 20 wherein speech element data are stored. The synthesized waveforms are outputted as a synthesized speech via a speaker 22. The speech element data are basic units of speech, for forming a synthesized waveform by joining themselves together, and various types of speech element data according to types of sound are stored in the memory 20 such as a ROM, and so forth.

With the Japanese-text to speech conversion system of the conventional type, using such a method of speech synthesis as described above, any text in Japanese can be read in the form of a synthesized speech, however, a problem has been encountered such that the synthesized speech as outputted is robotistic, thereby giving a listener feeling of monotonousness with the result that the listener gets bored or tired of listening the same.

### SUMMARY OF THE INVENTION

It is therefore an object of the invention to provide a Japanese-text to speech conversion system for outputting a synthesized speech without causing a listener to get bored or tired of listening.

Another object of the invention is to provide a Japanese-text to speech conversion system for replacing a synthesized speech waveform of a sound-related term selected among terms in a text with an actually recorded sound waveform, thereby outputting a synthesized speech for the text in whole.

Still another object of the invention is to provide a Japanese-text to speech conversion system for concurrently outputting synthesized speech waveforms of all the terms in the text, and an actually recorded sound waveform of a sound-related term among the terms in the text, thereby outputting a synthesized speech.

To this end, a Japanese-text to speech conversion system according to the invention is comprised as follows.

The system according to the invention comprises a text-to-speech conversion processing unit, and a phrase dictionary as well as a waveform dictionary, connected independently from each other to the conversion processing unit. The conversion processing unit is for converting any Japanese text inputted from outside into speech. In the phrase dictionary, notations of sound-related terms such as onomatopoeic words, background sounds, lyrics, music titles, and so forth, are previously registered. Further, in the waveform dictionary, waveform data obtained from the actually recorded sounds, corresponding to the sound-related terms, are previously registered.

Furthermore, the conversion processing unit is constituted such that as for a term in the text matching the sound-related term registered in the phrase dictionary upon collation of the former with the latter, actually recorded sound waveform data corresponding to the relevant sound-related term matching the term in the text, registered in the waveform dictionary, is outputted as a speech waveform of the term. The conversion processing unit is preferably constituted such that a synthesized speech waveform of the text in whole and the actually recorded sound waveform data are outputted independently from each other or concurrently.

With the constitution of the system according to the invention as described above, in the case of the sound-related term being an onomatopoeic word, lyrics, so forth, an actually recorded sound is interpolated in the synthesized speech of the text before outputted, thereby adding a sense of reality to the output of the synthesized speech.

Further, with the constitution as described above, in the case of the sound-related term being a background sound, music title, and so forth, the actually recorded sound is outputted like BGM concurrently with the output of the synthesized speech of the text in whole, thereby rendering the output of the synthesized speech well worth listening.

### BRIEF DESCRIPTION OF THE DRAWINGS

FIG. 1 is a block diagram of a conventional Japanese-text to speech conversion system;

FIG. 2 is a block diagram showing the constitution of the first embodiment of a Japanese-text to speech conversion system according to the invention by way of example;

FIG. 3 is a schematic illustration of an example of coupling a synthesized speech waveform with the actually recorded sound waveform of an onomatopoeic word according to the first embodiment;

FIGS. 4A and 4B are operation flow charts of the text analyzer according to the first embodiment;

FIGS. 5A and 5B are operation flow charts of the rule-based speech synthesizer according to the first embodiment and the fifth embodiment;

FIG. 6 is a block diagram showing the constitution of the second embodiment of a Japanese-text to speech conversion system according to the invention by way of example;

FIG. 7 is a schematic view illustrating an example of superimposing a synthesized speech waveform on the actually recorded sound waveform of a background sound according to the second embodiment;

FIGS. 8A, 8B are operation flow charts of the text analyzer according to the second embodiment;

FIGS. 9A to 9C are operation flow charts of the rule-based speech synthesizer according to the second embodiment;

FIG. 10 is a block diagram showing the constitution of the third embodiment of a Japanese-text to speech conversion system according to the invention by way of example;

FIG. 11 is a schematic view illustrating an example of coupling a synthesized speech waveform with the synthesized speech waveform of a singing voice according to the third embodiment;

FIGS. 12A, 12B are operation flow charts of the text analyzer according to the third embodiment;

FIGS. 13 is operation flow chart of the rule-based speech synthesizer according to the third embodiment;

FIG. 14 is a block diagram showing the constitution of the fourth embodiment of a Japanese-text to speech conversion system according to the invention by way of example;

FIG. 15 is a schematic view illustrating an example of superimposing a synthesized speech waveform on a musical sound waveform according to the fourth embodiment;

FIGS. 16A, 16B are operation flow charts of the text analyzer according to the fourth embodiment;

FIGS. 17A to 17C are operation flow charts of the rule-based speech synthesizer according to the fourth embodiment;

FIG. 18 is a block diagram showing the constitution of the fifth embodiment of a Japanese-text to speech conversion system according to the invention by way of example;

FIGS. 19A, 19B are operation flow charts of the text analyzer according to the fifth embodiment;

FIG. 20 is a block diagram showing the constitution of the sixth embodiment of a Japanese-text to speech conversion system according to the invention by way of example; and

FIGS. 21A, 21B are operation flow charts of the controller according to the sixth embodiment.

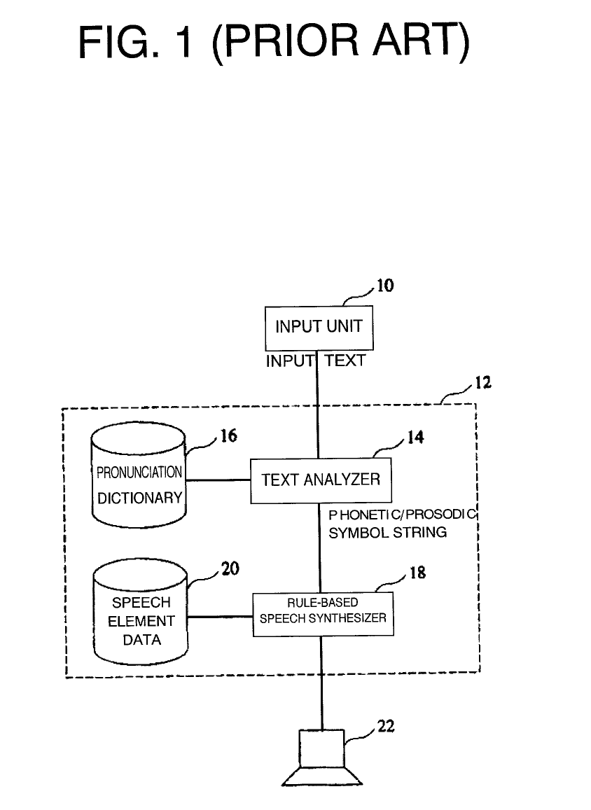

### DETAILED DESCRIPTION OF THE PREFERRED EMBODIMENTS

First Embodiment

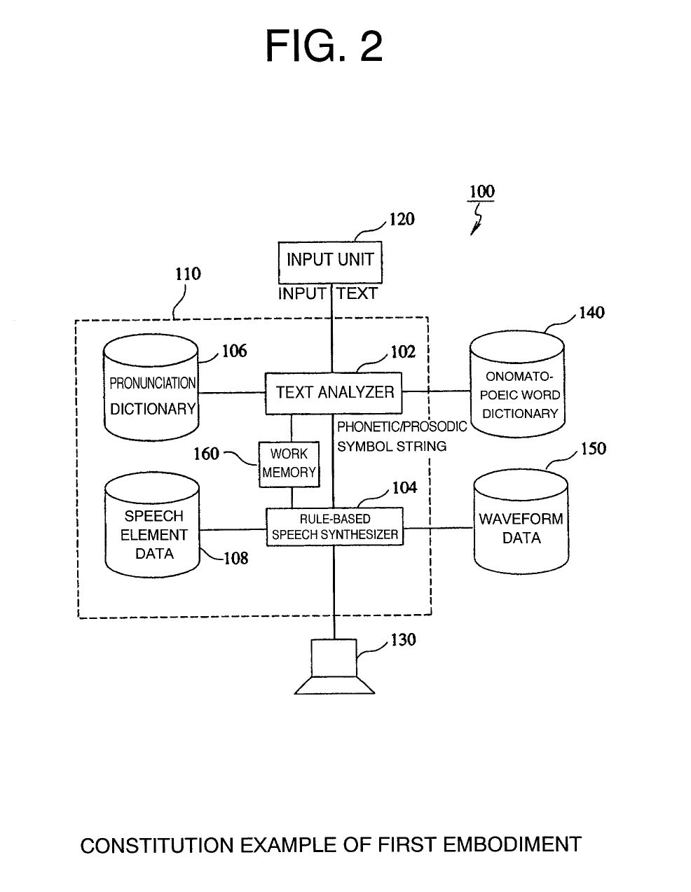

FIG. 2 is a block diagram showing the constitution example of the first embodiment of a Japanese-text to speech conversion system according to the invention. The system 100 comprises a text-to-speech conversion processing unit 110 provided with an input unit 120 for capturing input data from outside in order to cause an input text in the form of electronic data to be inputted to the conversion processing unit 110, and a speech conversion unit, for example, a speaker 130, for outputting speech waveforms synthesized by the conversion processing unit 110.

Further, the conversion processing unit 110 comprises a text analyzer 102 for converting the input text into a phonetic/prosodic symbol string thereof and outputting the same, and a rule-based speech synthesizer 104 for converting the phonetic/prosodic symbol string into a synthesized speech waveform and outputting the same to the speaker 130. Further, the conversion processing unit 110 is connected to the text analyzer 102 as well as a pronunciation dictionary 106 wherein pronunciation of respective words are registered, and to the rule-based speech synthesizer 104, further comprising a speech waveform memory (storage unit) 108 such as a ROM (read only memory), for storing speech element data. The rule-based speech synthesizer 104 converts the phonetic/prosodic symbol string outputted from the text analyzer 102 into a synthesized speech waveform on the basis of speech element data.

Table 1 shows an example of the registered contents of the pronunciation dictionary provided in the constitution of the first embodiment, and other embodiments described later on, respectively. A notation of words, part of speech, and pronunciation corresponding to the respective notations are shown in Table 1.

TABLE 1

| NOTATION | PART OF SPEECH | PRONUNCIATION |
|---|---|---|
| [symbol] | noun | a’me |
| [symbol] | verb | i |
| [symbol] | noun | inu’ |
| [symbol] | verb | utai |
| [symbol] | verb | utai |
| [symbol] | pronoun | ka’nojo |
| [symbol] | pronoun | ka’re |
| [symbol] | postposition | ga |
| [symbol] | noun | kimigayo |
| [symbol] | noun | sakura |
| [symbol] | adverb | shito’ shito |
| [symbol] | auxiliary verb | ta |
| [symbol] | postposition | te |
| [symbol] | postposition | to |
| [symbol] | verb | nai |
| [symbol] | interjection | nya’- |
| [symbol] | noun | ne’ ko |
| [symbol] | verb | hajime |
| [symbol] | postposition | wa |
| [symbol] | verb | fu’ t |
| [symbol] | verb | ho’ e |
| [symbol] | auxiliary verb | ma’ shi |
| [symbol] | interjection | wa’ n wan |
| . . . . | . . . | . . . . . |

The input unit 120 is provided in the constitution of the first embodiment, and other embodiments described later on, respectively, and as is well known, may be comprised as an optical reader, an input unit such as a keyboard, a unit made up of the above-described suitably combined, or any other suitable input means.

In addition, the system 100 is provided with a phrase dictionary 140 connected to the text analyzer 102 and a waveform dictionary 150 connected to the rule-based speech synthesizer 104. In the phrase dictionary 140, sound-related terms representing actually recorded sounds are previously registered. In this embodiment, the sound-related terms are onomatopoeic words, and accordingly, the phrase dictionary 140 is referred to as an onomatopoeic word dictionary 140. A notation for onomatopoeic words, and a waveform file name corresponding to the respective onomatopoeic words are listed in the onomatopoeic word dictionary 140.

Table 2 shows the registered contents of the onomatopoeic word dictionary by way of example. In Table 2, a notation of ┌ [symbol] ┘ (the onomatopoeic word of mewing by a cat), ┌ [symbol] ┘ (the onomatopoeic word of barking by a dog), ┌ [symbol] ┘ (the onomatopoeic word of the sound of a chime), ┌ [symbol] ┘ (the onomatopoeic word of the sound of a hard ball hitting a baseball bat), and so forth, respectively, and a waveform file name corresponding to the respective notations are listed by way of example.

TABLE 2

| NOTATION | WAVEFORM FILE NAME |
|---|---|
| [symbol] | CAT. WAV |
| [symbol] | DOG. WAV |
| [symbol] | BELL. WAV |
| [symbol] | BAT. WAV |
| . . . | . . . |

In the waveform dictionary 150, waveform data obtained from actually recorded sounds, corresponding to the sound-related terms listed in the onomatopoeic word dictionary 140, are stored as waveform files. The waveform files include original sound data obtained by actually recording sounds and voices. For example, in a waveform file “CAT.WAV” corresponding to the notation ┌ [symbol] ┘, a sound waveform of recorded mewing is stored. In this connection, a sound waveform obtained by recording is also referred to as an actually recorded sound waveform or natural sound waveform.

The conversion processing unit 110 has a function such that if there is found a term matching one of the sound-related terms registered in the phrase dictionary 140 among terms of an input text, the actually recorded sound waveform data of the relevant term is substituted for a synthesized speech waveform obtained by synthesizing speech element data, and is outputted as waveform data of the relevant term.

Further, the conversion processing unit 110 comprises a work memory 160. The work memory 160 is a memory for temporarily retaining information and data, necessary for processing in the text analyzer 102 and the rule-based speech synthesizer 104, or generated by such processing. The work memory 160 is installed as a memory for common use between the text analyzer 102 and the rule-based speech synthesizer 104, however, the work memory 160 may be installed inside or outside of the text analyzer 102 and the rule-based speech synthesizer 104, individually.

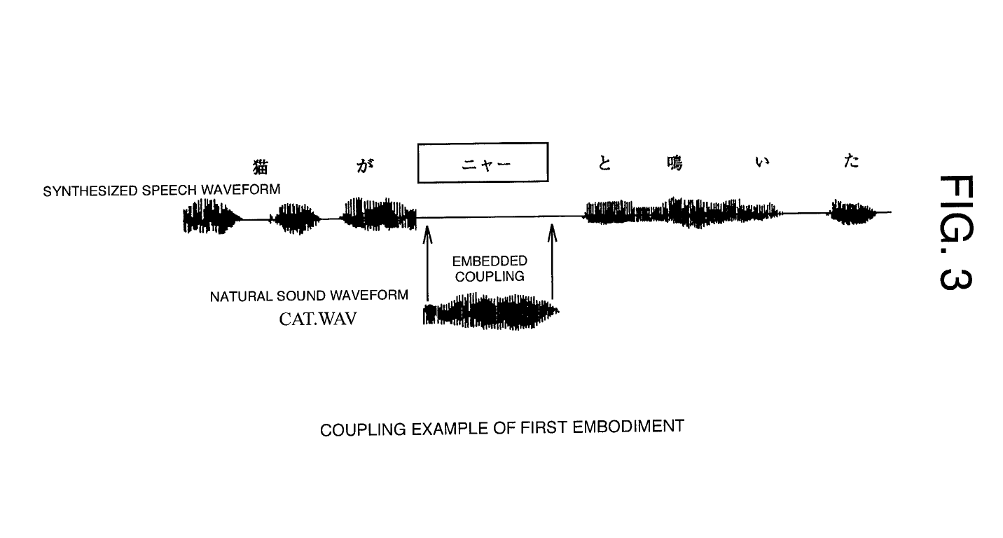

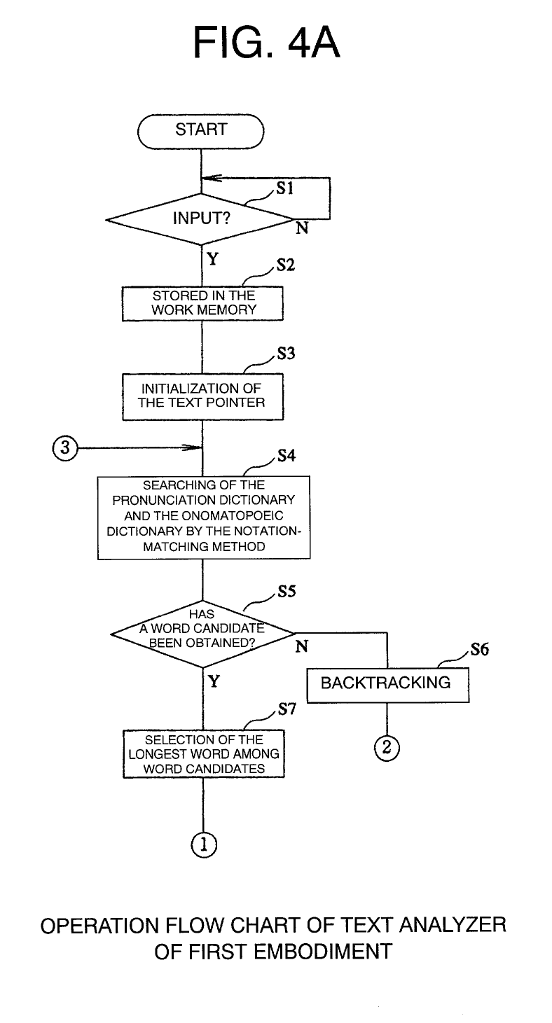

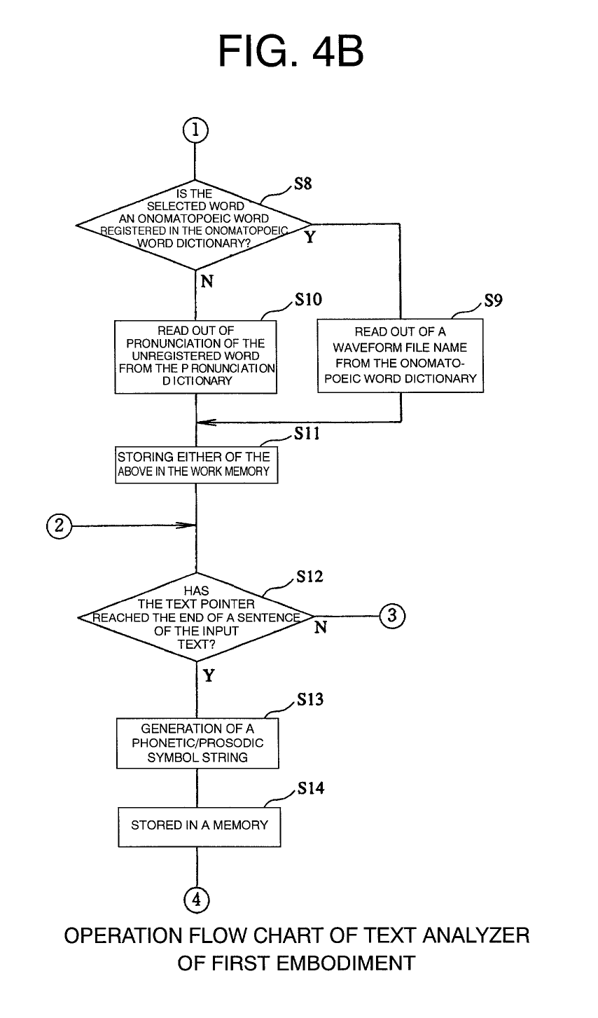

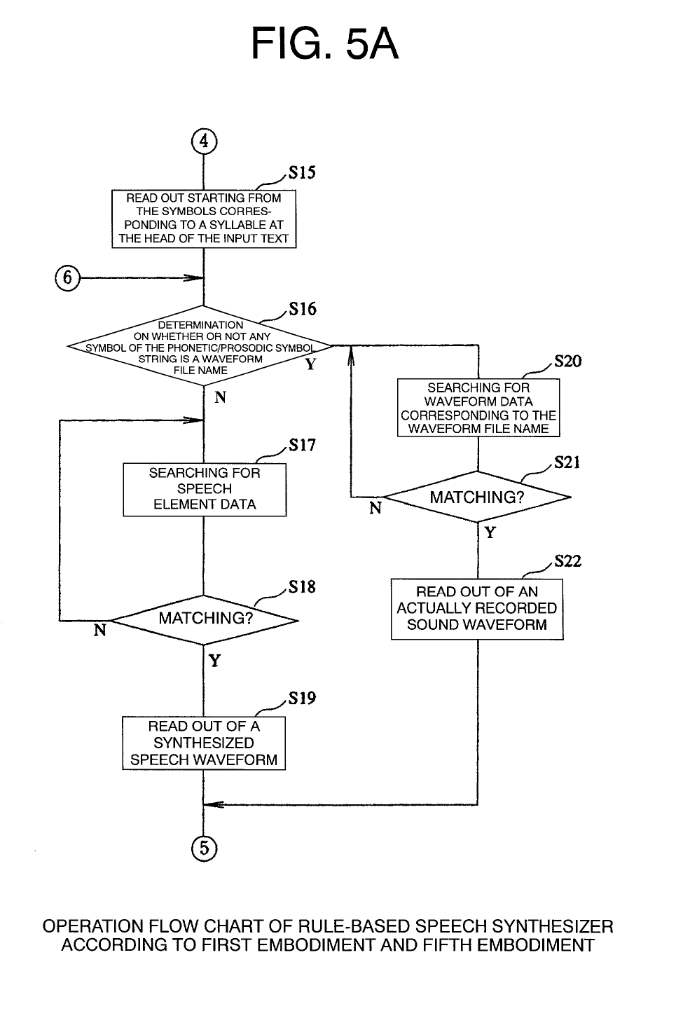

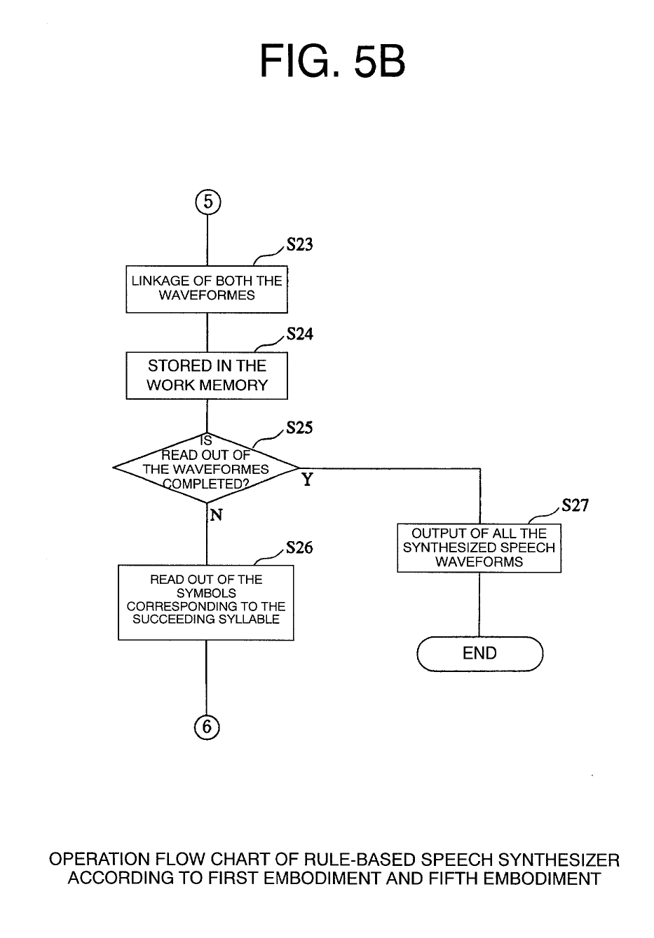

Now, operation of the Japanese-text to speech conversion system constituted as shown in FIG. 2 is described by giving a specific example. FIG. 3 is a schematic view illustrating an example of coupling a synthesized speech waveform with the actually recorded sound waveform of an onomatopoeic word. FIGS. 4A and 4B are operation flow charts of the text analyzer for explaining such an operation, and FIGS. 5A and 5B are operation flow charts of the rule-based speech synthesizer for explaining such an operation. In these operation flow charts, each step of processing is denoted by a symbol S with a number attached thereto.

For example, an input text in Japanese is assumed to read as ┌ [symbol] ┘. The input text is read by the input unit 120 and is inputted to the text analyzer 102.

The text analyzer 102 determines whether or not the input text is inputted (refer to the step S1 in FIG. 4A). Upon verification of input, the input text is stored in the work memory 160 (refer to the step S2 in FIG. 4A).

Subsequently, the input text is divided into words by use of the longest string-matching method, that is, by use of the longest word with a notation matching the input text. Processing by the longest string-matching method is executed as follows:

A text pointer p is initialized by setting the text pointer p at the head of the input text to be analyzed (refer to the step S3 in FIG. 4A).

Subsequently, the pronunciation dictionary 106 and the onomatopoeic word dictionary 140 are searched by the text analyzer 102 in order to examine whether or not there exists a word with a notation (dictionary entry) matching the string beginning at the text pointer p (the notation-matching method), and satisfying connection conditions (refer to the step S4 in FIG. 4A). The connection conditions refer to conditions such as whether or not a word can exist at the head of a sentence if the word is at the head, whether or not a word can be grammatically connected to the preceding word if the word is in the middle of a sentence, and so forth.

Whether or not there exists a word satisfying the conditions in the pronunciation dictionary or the onomatopoeic word dictionary, that is, whether or not a word candidate can be obtained is searched (refer to the step S5 in FIG. 4A). In case that the word candidate can not be found by such searching, the processing backtracks (refer to the step S6 in FIG. 4A), and proceeds to the step S12 as described later on. Backtracking in this case means to move the text pointer p back to the head of the preceding word, and to attempt an analysis using a next candidate for the word.

Next, in case that the word candidates are obtained, the longest word is selected among the word candidates (refer to the step S7 in FIG. 4A). In this case, adjunctive words are preferably selected among word candidates of the same length, taking precedence over self-existent words. Further, in case that there is only one word candidate, such a word is selected beyond question.

Subsequently, the onomatopoeic word dictionary 140 is searched in order to examine whether or not the selected word is among the sound-related terms registered in the onomatopoeic word dictionary 140 (refer to the step S8 in FIG. 4B). This searching is also executed against the onomatopoeic word dictionary 140 by the notation-matching method.

In the case where a word with the same notation is registered in both the pronunciation dictionary 106 and the onomatopoeic word dictionary 140, use is to be made of the word registered in the onomatopoeic word dictionary 140, that is, the sound-related term.

In the case where the selected word is registered in the onomatopoeic word dictionary 140, a waveform file name is read out from the onomatopoeic word dictionary 140, and stored in the work memory 160 together with a notation for the selected word (refer to steps S9 and S11 in FIG. 4B).

On the other hand, in the case where the selected word is an unregistered word which is not registered in the onomatopoeic word dictionary 140, pronunciation of the unregistered word is read out from the pronunciation dictionary 106, and stored in the work memory 160 (refer to steps S10 and S11 in FIG. 4B).

The text pointer p is advanced by the length of the selected word, and analysis described above is repeated until the text pointer p comes to the end of a sentence of the input text, thereby dividing the input text into words from the head to the end of the sentence (refer to the step S12 in FIG. 4B).

In case that analysis described above is not completed until the end of the input text, the processing reverts to the step S4 whereas in case that the analysis processing is completed, pronunciation of the words is read out from the work memory 160, and the input text is rendered into a word-string punctuated by every word, simultaneously reading out waveform file names. In this case, the sentence reading as ┌ [symbol] ┘ is punctuated by words consisting of [symbol] ┘.

Herein, the symbol ┌ [symbol] ┘ is a symbol denoting punctuation of words.

Subsequently, in the text analyzer 102, a phonetic/prosodic symbol string is generated from the word-string by replacing an onomatopoeic word in the word-string with a waveform file name while basing other words therein on pronunciation thereof (refer to the step S13 in FIG. 4B).

If the respective words of the input text are expressed in relation to pronunciation of every word, the input text is turned into a word string of ┌ [symbol] (ne' ko)┘, ┌ [symbol] (ga)┘,┌ [symbol] (“CAT. WAV”)┘, ┌ [symbol] (to)┘,┌, [symbol] (nai)┘, and ┌ [symbol] (ta)┘. What is shown in round brackets is information on the words, registered in the pronunciation dictionary 106 and the onomatopoeic word dictionary 140, respectively, indicating pronunciation in the case of registered words of the pronunciation dictionary 106, and a waveform file name in the case of registered words of the onomatopoeic word dictionary 140 as previously described.

By use of the information on the respective words of the word string, that is, the information in the round brackets, the text analyzer 102 generates the phonetic/prosodic symbol string of ┌ne' ko ga, “CAT. WAV” to, nai ta┘, and registers the same in a memory (refer to the step S14 in FIG. 4B).

The phonetic/prosodic symbol string is generated based on the word-string, starting from the head of the word-string. The phonetic/prosodic symbol string is generated basically by joining together the information on the respective words, and a symbol ┌,┘ is inserted at positions of a phrase.

Subsequently, the phonetic/prosodic symbol is read out in sequence from the memory and is sent out to the rule-based speech synthesizer 104.

On the basis of the phonetic/prosodic symbol string of ┌ne' ko ga, “CAT. WAV”to, nai ta┘ as received, the rule-based speech synthesizer 104 reads out relevant speech element data from the speech waveform memory 108 storing speech element data, thereby generating a synthesized speech waveform. The steps of processing in this case are described hereinafter.

First, read out is executed starting from the symbols of the phonetic/prosodic symbol string corresponding to a syllable at the head of the input text (refer to the step S15 in FIG. 5A). The rule-based speech synthesizer 104 determines in sequence whether or not any symbol of the phonetic/prosodic symbol string as read out is a waveform file name (refer to the step S16 in FIG. 5A).

In the case where symbols of the phonetic/prosodic symbol string is not a waveform file name, access to the speech waveform memory 108 is made, and speech element data corresponding to the symbols are searched for (refer to steps S17 and 18 in FIG. 5A).

In the case where there exists the speech element data corresponding to the symbols,synthesized speech waveforms corresponding thereto are read out and are stored in the work memory 160 (refer to the step S19 in FIG. 5A).

On the other hand, in the case where there exists a waveform file name in the phonetic/prosodic symbol string, access to the waveform dictionary 150 is made, and waveform data corresponding to the waveform file name are searched for (refer to steps S20 and 21 in FIG. 5A).

The waveform data (that is, an actually recorded sound waveform or natural sound waveform) are read out from the waveform dictionary 150, and are stored in the work memory 160 (refer to the step S22 in FIG. 5A).

In this example, as “CAT. WAV” is interpolated in the phonetic/prosodic symbol string, a synthesized speech waveform for “ne' ko ga,” is first generated, and subsequently, the actually recorded sound waveform of the waveform file name “CAT. WAV” is read out from the waveform dictionary 150. Accordingly, the synthesized speech waveform as already generated and the actually recorded sound waveform are retrieved from the work memory 160, and both the waveforms are linked (coupled) together, thereby generating a synthesized speech waveform, and storing the same in the work memory 160 (refer to steps S23 and S24 in FIG. 5B).

In the case where read out of the waveforms corresponding to the phonetic/prosodic symbol string is incomplete, read out of the symbols of the succeeding syllable is executed (refer to steps S25 and S26 in FIG. 5B), and the processing reverts to the step S16, reading a waveform in the same manner as described in the foregoing.

As a result, since synthesized speech waveforms of “to, nai ta” are generated from the speech element data of the speech waveform memory 108 thereafter, such waveforms are coupled with the synthesized speech waveform of ┌ne' ko ga, “CAT. WAV”┘ as already generated (refer to steps S16 to S25). Finally, all synthesized speech waveforms corresponding to the input text are outputted (refer to a step S27 in FIG. 5B).

FIG. 3 is a synthesized speech waveform chart for illustrating the results of conversion processing of the input text. With the synthesized speech waveform in the figure, there is shown a state wherein a portion of the synthesized speech waveform, corresponding to a sound-related term ┌ [symbol] ┘ which is an onomatopoeic word, is replaced with a natural sound waveform. That is, the natural sound waveform is interpolated in a position of the term corresponding to ┌ [symbol] ┘, and is coupled with the rest of the synthesized speech waveform, thereby forming a synthesized speech waveform for the input text in whole.

In the case where a plurality of waveform file names are interpolated in the phonetic/prosodic symbol string, the same processing, that is, retrieval of a waveform from the respective waveform files and coupling of such a waveform with other waveforms already generated, is executed in a position of every interpolation. In the case where none of the waveform file names is interpolated in the phonetic/prosodic symbol string, the operation of the rule-based speech synthesizer 104 is the same as that in the case of the conventional system.

The synthesized speech waveform for the input text in whole, completed as described above, is outputted as a synthesized sound from the speaker 130.

With the system 100 according to the invention, portions of the input text, corresponding to onomatopoeic words, can be outputted in an actually recorded sound, respectively, so that a synthesized speech outputted can be a synthesized sound creating a greater sense of reality as compared with a case where the input text in whole is outputted in a synthesized sound only, thereby preventing a listener from getting bored or tired of listening.

Second Embodiment

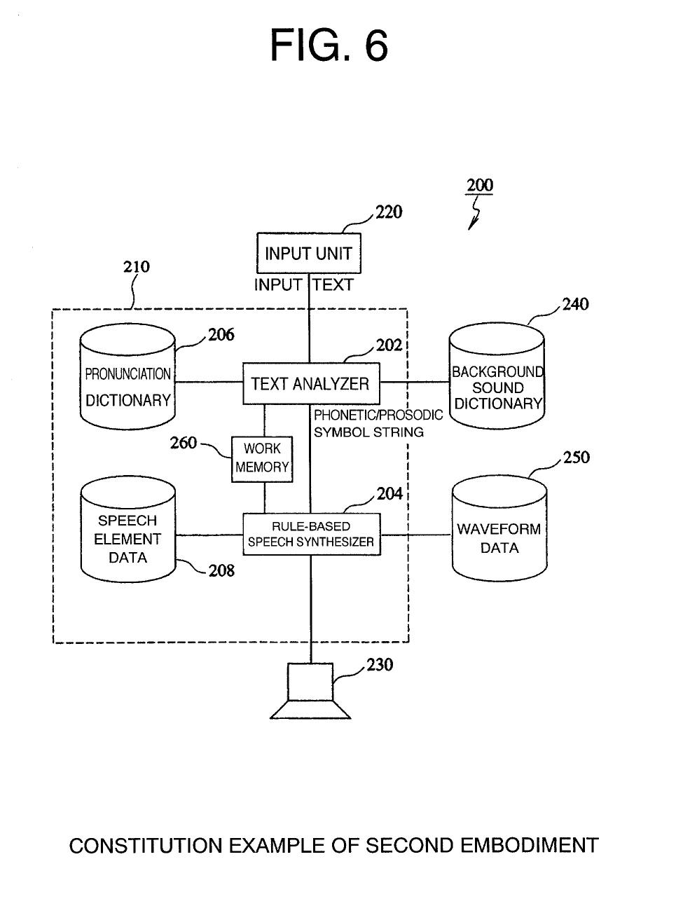

The second embodiment of a Japanese-text to speech conversion system according to the invention is described hereinafter with reference to FIGS. 6 to 9C. FIG. 6 is a block diagram showing the constitution, similar to that as shown in FIG. 2, of the system according to the second embodiment of the invention. The system 200 as well comprises a conversion processing unit 210, an input unit 220, a phrase dictionary 240, a waveform dictionary 250, and a speaker 230 that are connected in the same way as in the constitution shown in FIG. 2. Further, the conversion processing unit 210 comprises a text analyzer 202, a rule-based speech synthesizer 204, a pronunciation dictionary 206, a speech waveform memory 208 for storing speech element data, and a work memory 260 for fulfilling the same function as that for the work memory 160 that are connected in the same way as in the constitution shown in FIG. 2.

However, the registered contents of the phrase dictionary 240 and the waveform dictionary 250, respectively, differ in a kind of way from that of parts in the first embodiment, corresponding thereto, and further, the function of the text analyzer 202, and the rule-based speech synthesizer 204, composing the conversion processing unit 210, differs in a kind of way from that of those parts in the first embodiment, corresponding thereto, respectively. More specifically, the conversion processing unit 210 has a function such that, in the case where collation of a term in a text with a sound-related term registered in the phrase dictionary 240 shows matching therebetween, waveform data corresponding to a relevant sound-related term, registered in the waveform dictionary 250, is superimposed on a speech waveform of the text before outputted.

With the text-to-speech conversion system 200, sound-related terms for expressing background sound are registered in the phrase dictionary 240 connected to the text analyzer 202. The phrase dictionary 240 lists notations of the sound-related terms, that is, notations of background sounds, and waveform file names corresponding to such notations as registered information. Accordingly, the phrase dictionary 240 is constituted as a background sound dictionary.

Table 3 shows the registered contents of the background sound dictionary 240 by way of example. In Table 3, ┌ [symbol] , ┌ [symbol] ,┘, (a notation of various states of rainfall), ┌ [symbol] ┘, ┌ [symbol] ┘, (notations of clamorous states), and so forth, and waveform file names corresponding to such notations are listed by way of example.

TABLE 3

| NOTATION | WAVEFORM FILE NAME |
|---|---|
| [symbol] | RAIN 1. WAV |
| [symbol] | RAIN 2. WAV |
| [symbol] | LOUD. WAV |
| [symbol] | LOUD. WAV |
| . . . | . . . |

The waveform dictionary 250 stores waveform data obtained from actually recorded sounds, corresponding to the sound-related terms listed in the background sound dictionary 240, as waveform files. The waveform files represent original sound data obtained by actually recording sounds and voices. For example, in a waveform file “RAIN 1. WAV” corresponding to a notation ┌ [symbol] , an actually recorded sound waveform obtained by recording a sound of rain falling ┌ [symbol] (gently) is stored.

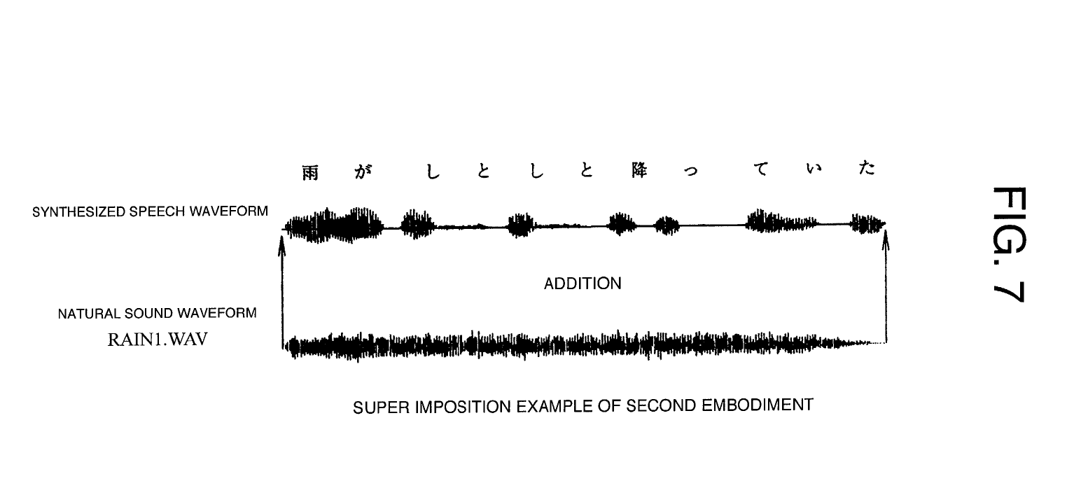

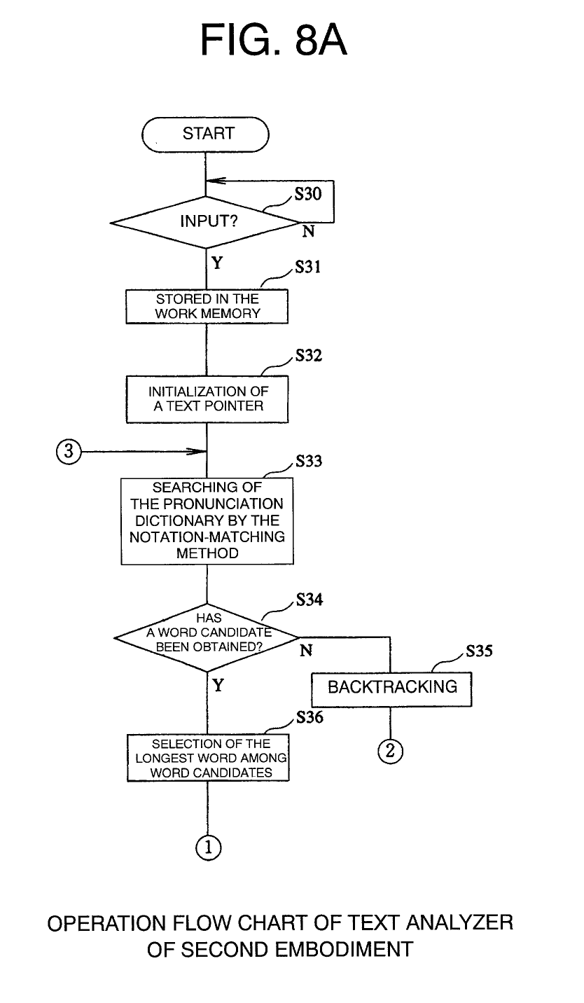

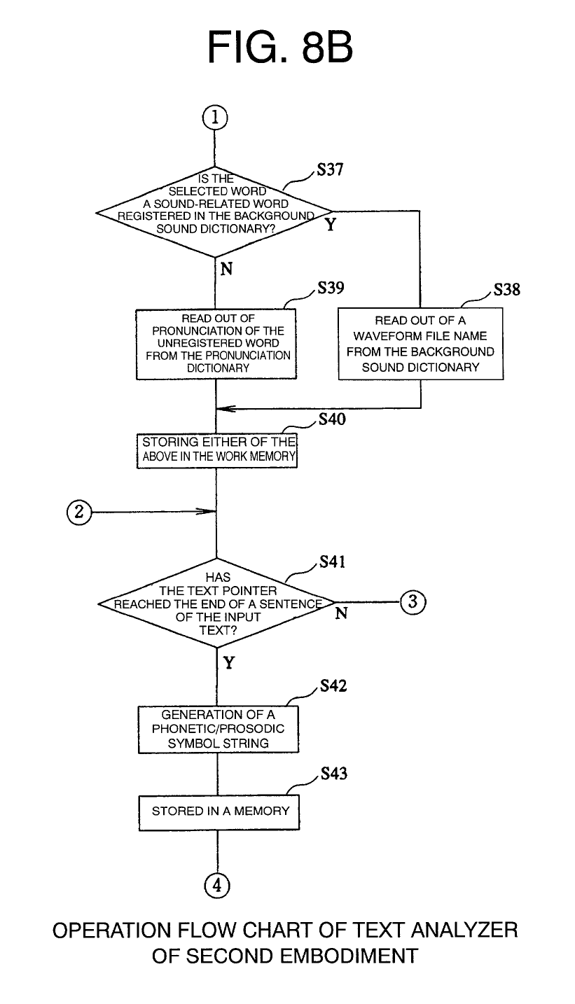

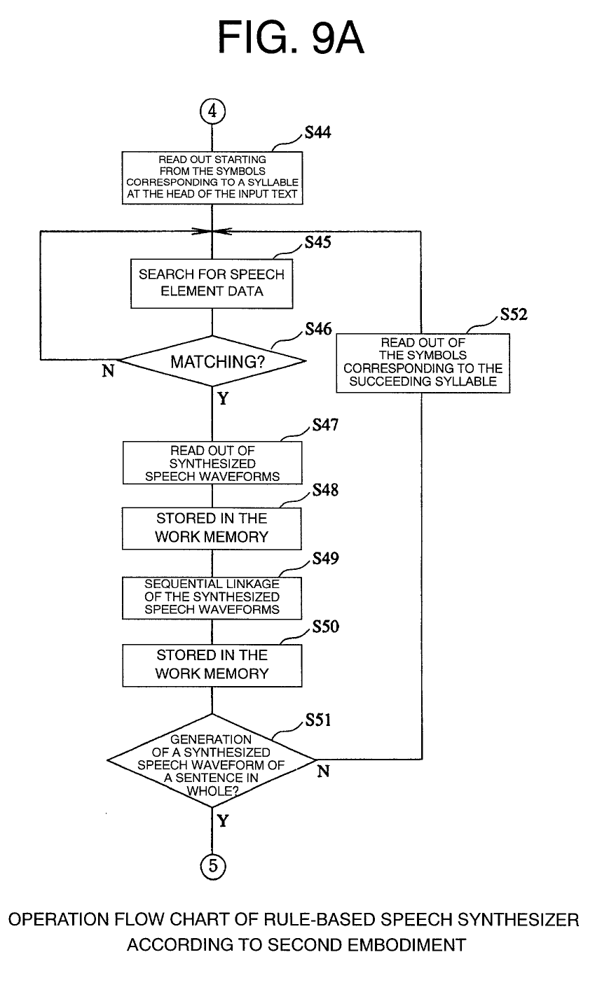

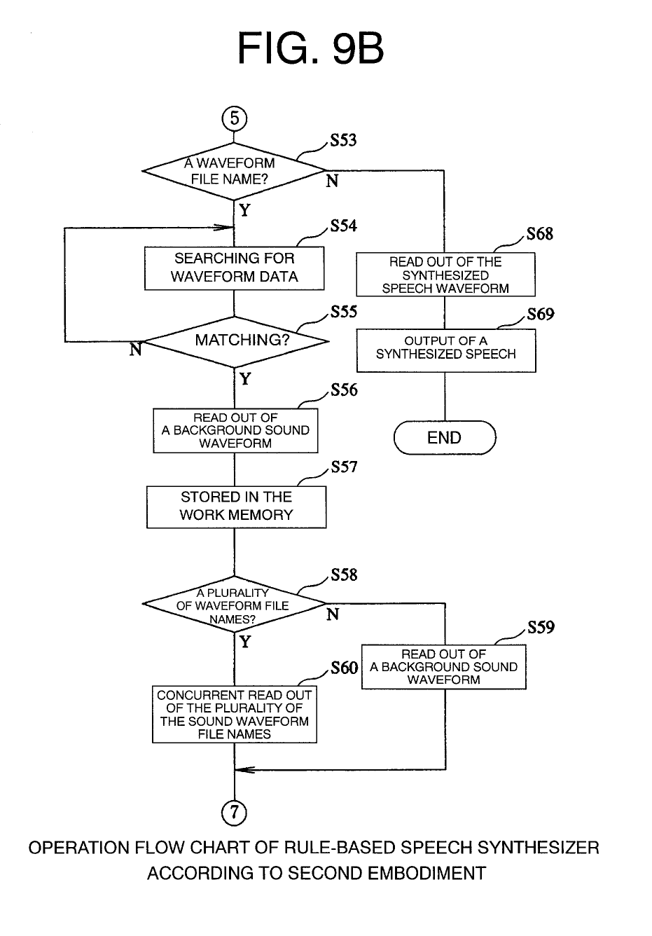

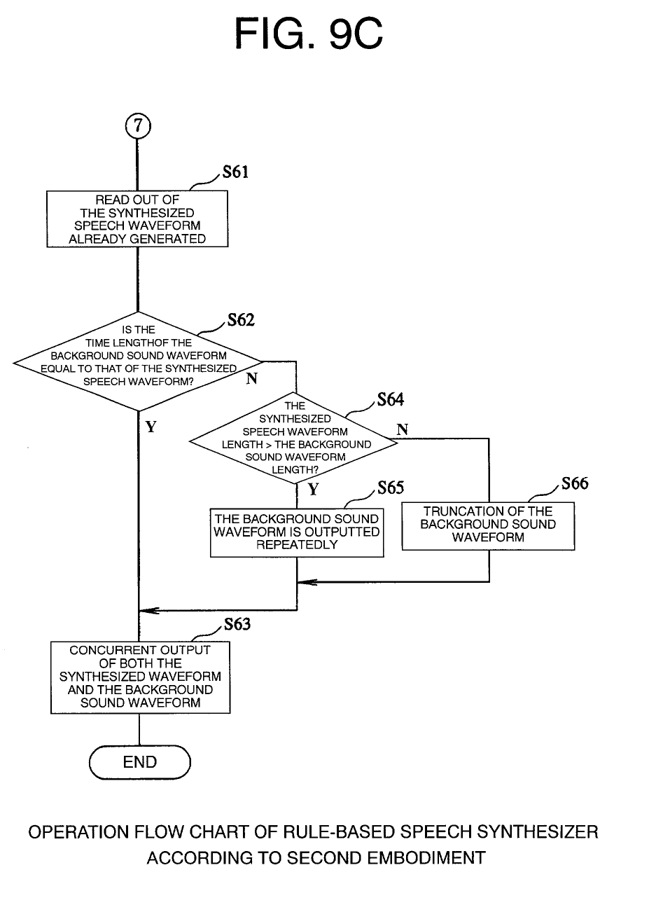

Now, operation of the Japanese-text to speech conversion system constituted as shown in FIG. 6 is described by citing a specific example. FIG. 7 is a schematic view illustrating an example of superimposing an actually recorded sound waveform (that is, a natural sound waveform) of a background sound on a synthesized speech waveform of the text in whole. The figure illustrates an example wherein the synthesized speech waveform of the text in whole and the recorded sound waveform of the background sound are outputted independently from each other, and concurrently. FIGS. 8A, 8B are operation flow charts of the text analyzer, and FIGS. 9A to 9BC are operation flow charts of the rule-based speech synthesizer.

For example, a case is assumed wherein an input text in Japanese reads as [symbol] . The input text is captured by the input unit 220 and inputted to the text analyzer 202, whereupon the input text is divided into words by the longest string-matching method in the same manner as described in the first embodiment. Processing for dividing the input text into words up to generation of a phonetic/prosodic symbol string is executed by taking the same steps as those for the first embodiment described with reference to FIGS. 4A, 4B and FIGS. 5A, 5B. Such processing is described hereinafter.

The text analyzer 202 determines whether or not an input text is inputted (refer to the step S30 in FIG. 8A). Upon verification of input, the input text is stored in the work memory 260 (refer to the step S31 in FIG. 8A).

Subsequently, the input text is divided into words by use of the longest string-matching method. Processing by the longest string-matching method is executed as follows:

A text pointer p is initialized by setting the text pointer p at the head of the input text to be analyzed (refer to the step S32 in FIG. 8A).

Subsequently, the pronunciation dictionary 206 is searched by the text analyzer 202 in order to examine whether or not there exists a word with a notation (dictionary entry) matching the string beginning at the text pointer p (the notation-matching method), and satisfying connection conditions (refer to the step S33 in FIG. 8A).

Whether or not there exist words satisfying the connection, that is, whether or not word candidates can be obtained is searched (refer to the step S34 in FIG. 8A). In case that the word candidates can not be found by such searching, the processing backtracks (refer to the step S35 in FIG. 8A), and proceeds to the step S41 as described later on.

Next, in case that the word candidates are obtained, the longest word is selected among the word candidates (refer to the step S36 in FIG. 8A). In this case, if there exist a plurality of the word candidates of the same length, adjunctive words are selected preferentially over self-existent words. Further, in case that there is only one word candidate, such a word is selected beyond question.

Subsequently, the background sound dictionary 240 is searched in order to examine whether or not the selected word is among the sound-related terms registered in the background sound dictionary 240 (refer to the step S37 in FIG. 8B). Such searching of the background sound dictionary 240 is executed by the notation-matching method as well.

In the case where the selected word is registered in the background sound dictionary 240, a waveform file name is read out from the background sound dictionary 240, and stored in the work memory 260 together with a notation for the selected word (refer to steps S38 and S40 in FIG. 8B).

On the other hand, in the case where the selected word is an unregistered word which is not registered in the background sound dictionary 240, the pronunciation of the unregistered word is read out from the pronunciation dictionary 206, and stored in the work memory 260 (refer to steps S39 and S40 in FIG. 8B).

The text pointer p is advanced by the length of the selected word, and analysis described above is repeated until the text pointer p comes to the end of a sentence of the input text, thereby dividing the input text into words from the head to the end of a sentence (refer to the step S41 in FIG. 8B).

In case that analysis described above is not completed until the end of the input text, the processing reverts to the step S33 whereas in case that the analysis processing is completed, the pronunciation of the words is read out from the work memory 260, and the input text is rendered into a word-string punctuated by every word, simultaneously reading a waveform file name. In this case, the sentence reading as [symbol] is punctuated by words consisting of [symbol] .

Subsequently, in the text analyzer 202, a phonetic/prosodic symbol string is generated from the word-string by replacing the background sound term in the word-string with a waveform file name while basing other words therein on pronunciation thereof (refer to the step S42 in FIG. 8B).

If the respective words of the input text are expressed in relation to the pronunciation of every word, the input text is turned into a word string of ┌ [symbol] (a' me)┘, [symbol] (ga)┘, ┌ [symbol] (shito' shito) ┘, ┌z,41 (fu' t) ┌, ┘ [symbol] (te) ┘, ┌ [symbol] (i)┘, and ┌ [symbol] (ta)┘. What is shown in round brackets is information on the words, registered in the pronunciation dictionary 206, that is, pronunciation of the words.

Thus, by use of the information on the respective words of the word string, that is, the information in the round brackets, the text analyzer 202 generates a phonetic/prosodic symbol string of ┌a' me ga, shito' shito, fu' tte ita┘. Meanwhile, referring to the background sound dictionary 240, the text analyzer 202 examines whether or not the respective words in the word string are registered in the background sound dictionary 240. Then, as ┌ [symbol] (RAIN 1. WAV)┘ is found registered therein, a waveform file name RAIN 1. WAV:, corresponding thereto, is added to the head of the phonetic/prosodic symbol string, thereby converting the same into a phonetic/prosodic symbol string of “RAIN 1. WAV: a' me ga, shito' shito, fu' tte ita”, and storing the same in the work memory 260 (refer to the step S43 in FIG. 8B). Thereafter, the phonetic/prosodic symbol string with the waveform file name attached thereto is sent out to the rule-based speech synthesizer 204.

In the case where a plurality of words representing background sounds registered in the background sound dictionary 240 are found included in the word string, all the waveform file names corresponding thereto are added to the head of the phonetic/prosodic symbol string as generated. In the case where none of the words representing background sounds registered in the background sound dictionary 240 is found included in the word string, the phonetic/prosodic symbol string as generated is sent out to the rule-based speech synthesizer 204 with no add-ons.

On the basis of the phonetic/prosodic symbol string of ┌RAIN 1. WAV: a' me ga, shito' shito, fu' tte ita┘ as received, the rule-based speech synthesizer 204 reads out relevant speech element data corresponding thereto from the speech waveform memory 208 storing speech element data, thereby generating a synthesized speech waveform. The steps of processing in this case are described hereinafter.

First, reading is executed starting from a symbol string, corresponding to a syllable at the head of the input text. The rule-based speech synthesizer 204 determines whether or not a waveform file name is attached to the head of the phonetic/prosodic symbol string representing pronunciation. Since the waveform file name “RAIN 1. WAV” is added to the head of the phonetic/prosodic symbol string, a waveform of ┌a' me ga, shito' shito, fu' tte ita┘ is generated from the speech waveform memory 208, and subsequently, the waveform of the waveform file “RAIN 1. WAV” is read out from the waveform dictionary 250. The latter waveform, and the waveform of ┌a' me ga, shito' shito, fu' tte ita┘ as already generated are outputted concurrently from the starting point of the waveforms, thereby superimposing one of the waveforms on the ot her before outputting.

In this case, if the waveform of “RAIN 1. WAV” is longer than the waveform of “a' me ga, shito' shito, fu' tte ita”, the former is truncated to the length of the latter, and the both are concurrently outputted. In such a case, the synthesized speech waveform can be superimposed on the waveform data on background sounds by such a simple processing as truncation.

Conversely, if the waveform of the waveform file “RAIN 1. WAV” is shorter in length than the waveform of “a' me ga, shito' shito, fu' tte ita”, processing is executed such that the former is added up by connecting the same in succession repeatedly until the length of the latter is reached. In this way, it is possible to prevent the waveform data on the background sounds from coming to the end thereof sooner than the synthesized speech waveform comes to the end thereof.

In the case where a plurality of waveform file names are added to the head of the phonetic/prosodic symbol string, the same processing as described above, that is, reading of a waveform from waveform files, and addition of the waveform to the waveform already generated, is applied to all of the plurality of the waveform files. For example, in the case where “RAIN 1. WAV: LOUD. WAV:” is added to the head of the phonetic/prosodic symbol string, waveforms of both the sound of rainfall and the sound of crowds are superimposed on the synthesized speech waveform. In the case where none of the waveform file names is added to the head of the phonetic/prosodic symbol string, the operation of the rule-based speech synthesizer 204 is the same as that in the case of the conventional system.

The processing operation described above is executed as follows.

First, read out is executed starting from a symbol string corresponding to a syllable at the head of the input text (refer to the step S44 in FIG. 9A). The rule-based speech synthesizer 204 determines by such reading whether or not a waveform file name is attached to the head of the phonetic/prosodic symbol string. As a result, access to the speech waveform memory 208 is made by the rule-based speech synthesizer 204, and speech element data corresponding to respective symbols of the phonetic/prosodic symbol string following the waveform file name, are searched for (refer to steps S45 and S46 in FIG. 9A).

In the case where there exist speech element data corresponding to the respective symbols, a synthesized speech waveform corresponding thereto is read out, and stored in the work memory 260 (refer to steps S47 and S48 in FIG. 9A).

The synthesized speech waveforms corresponding to the symbols are linked with each other in the order as read out, the result of which is stored in the work memory 260 (refer to steps S49 and S50 in FIG. 9A).

Subsequently, the rule-based speech synthesizer 204 determines whether or not a synthesized speech waveform of the sentence in whole as represented by the phonetic/prosodic symbol string of ┌a' me ga, shito' shito, fu' tte ita┘ has been generated (refer to the step S51 in FIG. 9A). In case it is determined as a result that the synthesized speech waveform of the sentence in whole has not been generated as yet, a command to read out a symbol string corresponding to the succeeding syllable is issued (refer to the step S52 in FIG. 9A), and the processing reverts to the step S45.

In the case where it is determined that the synthesized speech waveform of the sentence in whole has already been generated, the rule-based speech synthesizer 204 reads out a waveform file name (refer to the step S53 in FIG. 9B). In the case of the embodiment described herein, since there exists a waveform file name, access to the waveform dictionary 250 is made, and waveform data is searched for (refer to steps S54 and S55 in FIG. 9B).

As a result of such searching, a background sound waveform corresponding to a relevant waveform file name is read out from the waveform dictionary 250, and stored in the work memory 260 (refer to steps S56 and S57 in FIG. 9B).

Subsequently, upon completion of read out of the background sound waveform corresponding to the waveform file name, the rule-based speech synthesizer 204 determines whether one waveform file name exists or a plurality of waveform file names exist (refer to the step S58 in FIG. 9B). In the case where only one waveform file name exists, a background sound waveform corresponding thereto is read out from the work memory 260 (refer to the step S59 in FIG. 9B), and in the case where the plurality of the waveform file names exist, all background sound waveforms corresponding thereto are read out from the work memory 260 (refer to the step S60 in FIG. 9B).

After completion of reading of the background sound waveform (or while reading of the background sound waveform), the synthesized speech waveform already generated is read out from the work memory 260 (refer to the step S61 in FIG. 9C).

Upon completion of reading of both the background sound waveform and the synthesized speech waveform, the length of the background sound waveforms is compared with that of the synthesized speech waveform (refer to the step S62 in FIG. 9C).

In case that the time length of the background sound waveform is equal to that of the synthesized speech waveform, both the background sound waveform and the synthesized speech waveform are outputted in parallel in time, that is, concurrently from the rule-based speech synthesizer 204.

In case that the time length of the background sound waveform is not equal to that of the synthesized speech waveform, whether or not the synthesized speech waveform is longer than the background sound waveform is determined (refer to the step S64 in FIG. 9C). In case that the background sound waveform is shorter than the synthesized speech waveform, the background sound waveform is outputted repeatedly while outputting the synthesized speech waveform until the time length of the repeated background sound waveform matches that of the synthesized speech waveform (refer to steps S65 and S63 in FIG. 9C).

On the other hand, in case that the background sound waveform is longer than the synthesized speech waveform, the background sound waveform which is truncated to the length of the synthesized speech waveform is outputted while outputting the synthesized speech waveform (refer to steps S66 and S63 in FIG. 9C).

Thus, it is possible to output both the background sound waveform and the synthesized speech waveform that are superimposed on each other from the rule-based speech synthesizer 204 to the speaker 230.

Further, in the case where no waveform file names are attached to the head of the phonetic/prosodic symbol string since the sound-related term concerning the background sound is not included in the input text, the processing proceeds from the step S37 to the step S39. As there exists no waveform file name, the rule-based speech synthesizer 204 reads out the synthesized speech waveform only in the step S53, and outputs a synthesized speech only (refer to steps S68 and S69 in FIG. 9B).

FIG. 7 shows an example of superimposition of waveforms. In the case of this embodiment, there is shown a state wherein the natural sound waveform of the background sound is outputted at the same time the synthesized speech waveform of ┌ [symbol] ┘ is outputted. That is, during the identical time period from the starting point of the synthesized speech waveform to the end point thereof, the natural sound waveform of the background sound is outputted.

A synthesized speech waveform of the input text in whole, thus generated, is outputted from the speaker 230.

With the use of the system 200 according to this embodiment of the invention, an actually recorded sound can be outputted as the background sound against the synthesized speech, and thereby the synthesized speech outputted can be a synthesized sound creating a greater sense of reality as compared with a case wherein the input text in whole is outputted in a synthesized sound only, so that a listener will not get bored or tired of listening. Further, with the system 200, it is possible through a simple processing to superimpose waveform data of actually recorded sounds such as background sound on the synthesized speech waveform of the input text.

Third Embodiment

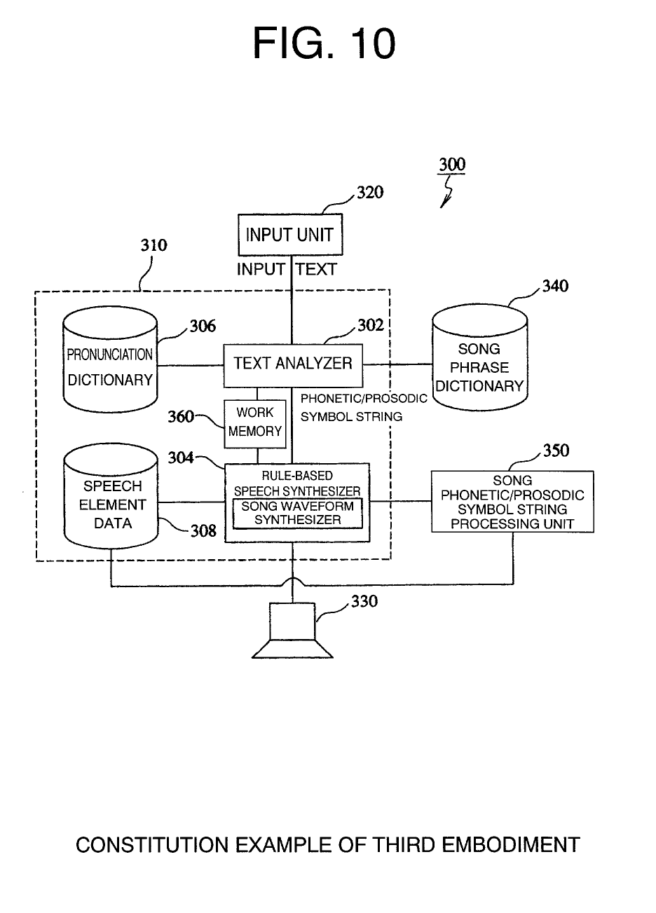

The third embodiment of a Japanese-text to speech conversion system according to the invention is described hereinafter with reference to FIGS. 10 to 13. FIG. 10 is a block diagram showing the constitution, similar to that shown in FIG. 2, of the system according to this embodiment. The system 300 as well comprises a conversion processing unit 310, an input unit 320, a phrase dictionary 340, and a speaker 330 that are connected in the same way as in the constitution shown in FIG. 2. Further, the conversion processing unit 310 comprises a text analyzer 302, a rule-based speech synthesizer 304, a pronunciation dictionary 306, a speech waveform memory 308 for storing speech element data, and a work memory 360 for fulfilling the same function as that of the work memory 160 previously described that are connected in the same way as in the constitution shown in FIG. 2.

With the system 300, however, the registered contents of the phrase dictionary 340 differ from that of the part corresponding thereto, in the first and second embodiments, respectively, and further, the function of the text analyzer 302 and the rule-based speech synthesizer 304, composing the conversion processing unit 310, respectively, differs somewhat from that of parts corresponding thereto, in the first and second embodiments, respectively.

In the case of the system 300, a song phrase dictionary is installed as the phrase dictionary 340. In the song phrase dictionary 340 connected to the text analyzer 302, notations for song phrases, and a song phonetic/prosodic symbol string, corresponding to the respective notations, are listed. The song phonetic/prosodic symbol string refers to a character string describing lyrics and a musical score, and, for example, ┌ [symbol] 2┘ indicates generation of a sound “ [symbol] ” (a) at a pitch ┌ [symbol] ┘ (do) for a duration of a half note.

Further, in the case of the system 300, a song phonetic/prosodic symbol string processing unit 350 is installed so as to be connected to the rule-based speech synthesizer 304. The song phonetic/prosodic symbol string processing unit 350 is connected to the speech waveform memory 308 as well. The song phonetic/prosodic symbol string processing unit 350 is used for generation of a synthesized speech waveform of singing voices from speech element data of the speech waveform memory 308 by analyzing relevant song phonetic/prosodic symbol strings.

Table 4 shows the registered contents of the song phrase dictionary 340 by way of example. In Table 4, a notation of songs such as “ [symbol] ”, and so forth, respectively, and a song phonetic/prosodic symbol string corresponding to the respective notations are shown by way of example.

TABLE 4

| | song phonetic/prosodic |
|---|---|
| NOTATION | symbol string |
| [symbol] | [symbol] d16 [symbol] d8 [symbol] d16 [symbol] d8. [symbol] f16 [symbol] |
| | g8. [symbol] f16 [symbol] g4 |
| [symbol] | [symbol] a4 [symbol] a4 [symbol] b2 [symbol] a4 [symbol] a4 [symbol] b2 |
| [symbol] | [symbol] d8. [symbol] e18 [symbol] f8. [symbol] f16 [symbol] e8 [symbol] |
| | e16 [symbol] e16 [symbol] d8. [symbol] d16 |
| — | — |

In the song phonetic/prosodic symbol string processing unit 350, song phonetic/prosodic symbol strings inputted thereto are analyzed. By such analytical processing, when linking the waveform of, for example, a syllable ┌ [symbol] (a)┘ of the previously described ┌ [symbol] 2┘ with the waveform of a preceding waveform, the waveform of the syllable ┌ [symbol] (a)┘ is linked such that a sound thereof will be at a pitch c (do) and a duration of the sound will be a half note. That is, by use of an identical speech element data, it is possible to form both a waveform of ┌ [symbol] (a)┘ of a normal speech voice and a waveform of ┌ [symbol] (a)┘ of a singing voice. In other words, in the song phonetic/prosodic symbol strings, a syllable with a symbol such as ┌ [symbol] 2┘ attached thereto forms a waveform of a singing voice while a syllable without such a symbol attached thereto forms a waveform of a normal speech voice.

The conversion processing unit 310 collates lyrics in a text with lyrics registered in the song phrase dictionary 340, and, in the case where the former matches the latter, outputs a speech waveform generated on the basis of a song phonetic/prosodic symbol string paired with the relevant lyrics registered in the song phrase dictionary 340 as a waveform of the lyrics.

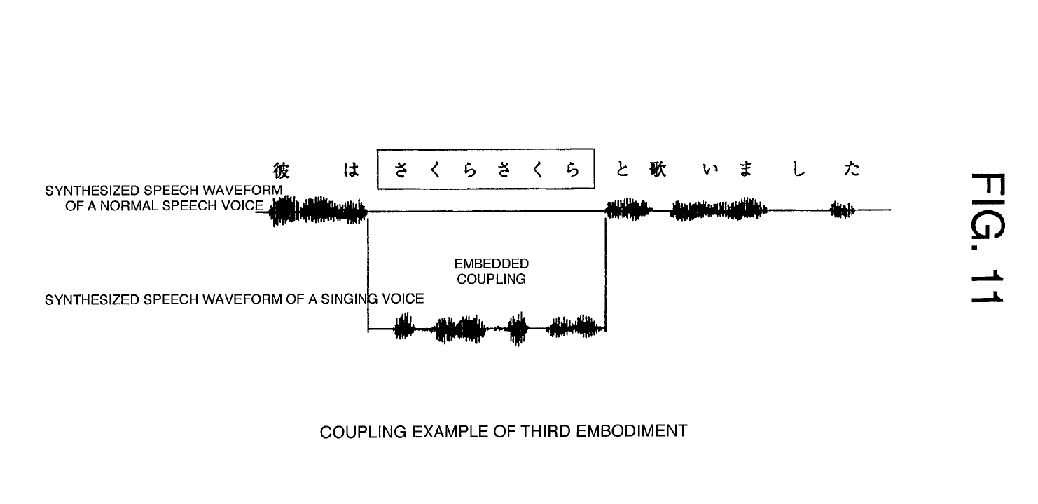

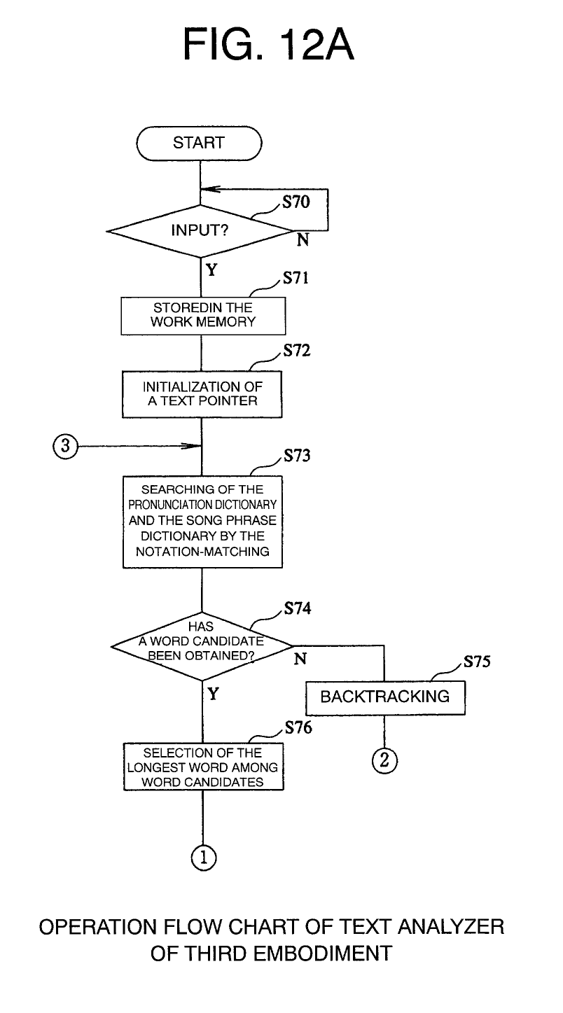

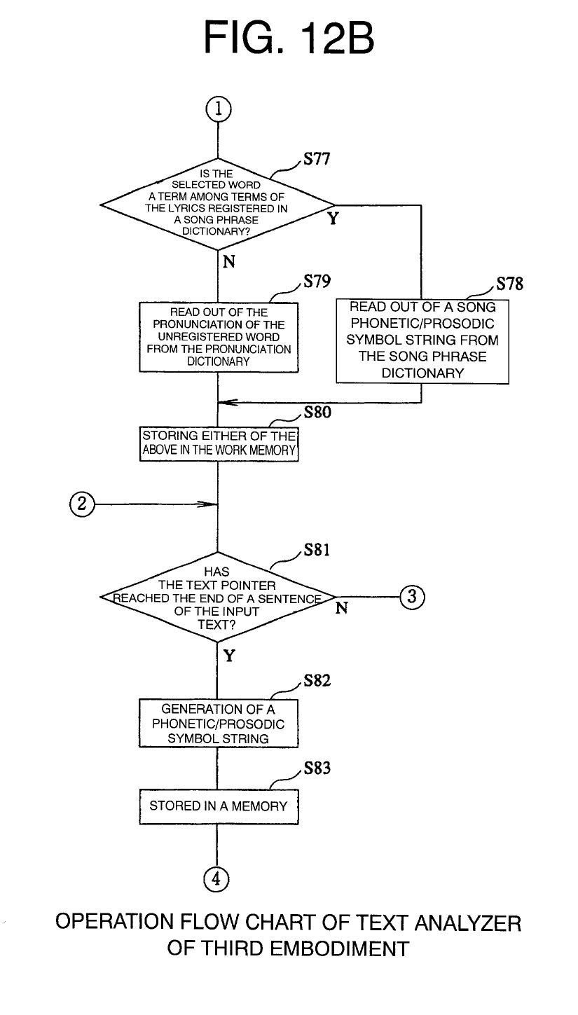

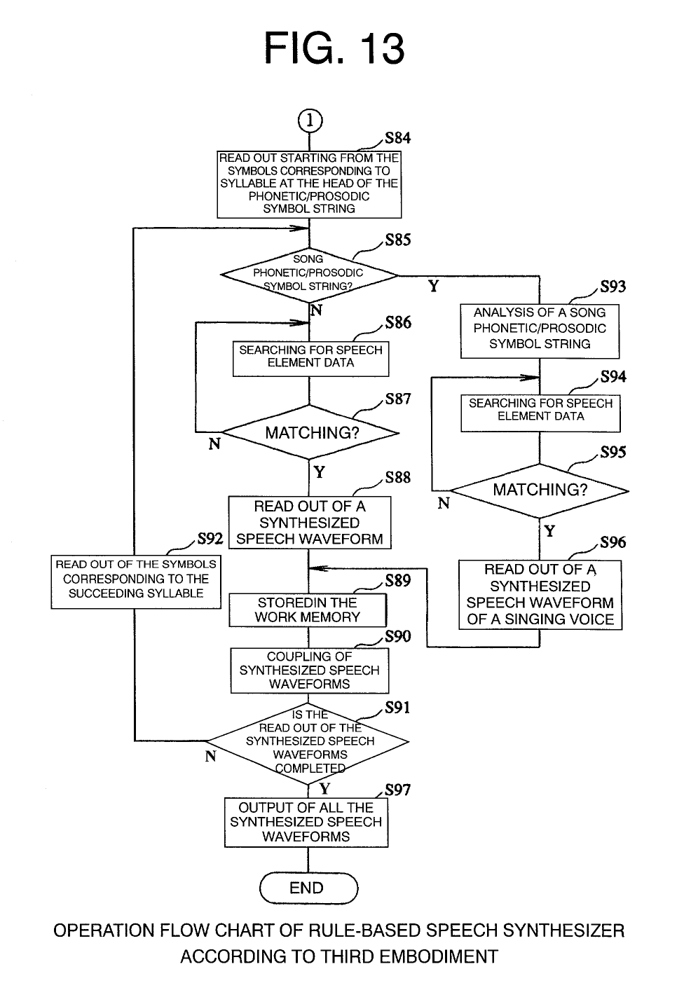

Now, operation of the Japanese-text to speech conversion system 300 constituted as shown in FIG. 10 is described by citing a specific example. FIG. 11 is a view illustrating an example of coupling a synthesized speech waveform of portions of the text, excluding the lyrics, with a synthesized speech waveform of a singing voice. The figure illustrates an example wherein the synthesized speech waveform of the singing voice in place of a normal synthesized speech waveform corresponding to the lyrics in the text, is interpolated in the synthesized speech waveform of the portions of the text, and coupled therewith, thereby outputting an integrated synthesized speech waveform. FIGS. 12A, 12B are operation flow charts of the text analyzer 302, and FIG. 13 is an operation flow chart of the rule-based speech synthesizer 304.

For example, a case is assumed wherein an input text in Japanese reads as ┌ [symbol] ┘. The input text is captured by the input unit 320 and inputted to the text analyzer 302, whereupon processing of dividing the input text into words by the longest string-matching method in the same manner as described in the first embodiment is executed. For processing from dividing the input text into words up to generation of a phonetic/prosodic symbol string, the same steps as those described with reference to FIGS. 4A, 4B are taken, and these steps are described hereinafter.

The text analyzer 302 determines whether or not an input text is inputted (refer to the step S70 in FIG. 12A). Upon verification of input, the input text is stored in the work memory 360 (refer to the step S71 in FIG. 12A).

Subsequently, the input text is divided into words by use of the longest string-matching method. Processing by the longest string-matching method is executed as follows:

A text pointer p is initialized by setting the text pointer p at the head of the input text to be analyzed (refer to the step S72 in FIG. 12A).

Subsequently, the pronunciation dictionary 306 and the song phrase dictionary 340 are searched by the text analyzer 302 in order to examine whether or not there exists a word with a notation (dictionary entry) matching the string beginning at the text pointer p (the notation-matching method), and satisfying connection conditions (refer to the step S73 in FIG. 12A).

Whether or not there exist words satisfying the conditions in the pronunciation dictionary 306 or the song phrase dictionary 340, that is, whether or not word candidates can be obtained is searched (refer to the step S74 in FIG. 12A). In case the word candidates can not be found by such searching, the processing backtracks (refer to the step S75 in FIG. 12A), and proceeds to the step S81 as described later on.

Next, in the case where the word candidates are obtained, the longest word is selected among the word candidates (refer to the step S76 in FIG. 12A). In this case, if there exist a plurality of the word candidates of the same length, adjunctive words are selected preferentially over self-existant words. Further, in case that there is only one word candidate, such a word is selected beyond question.

Subsequently, the song phrase dictionary 340 is searched in order to examine whether or not a selected word is among terms of the lyrics registered in the song phrase dictionary 340 (refer to the step S77 in FIG. 12B). Such searching is also executed against the song phrase dictionary 340 by the notation-matching method.

In the case where a word with an identical notation, that is, a term of the lyrics is registered in both the pronunciation dictionary 306 and the song phrase dictionary 340, the word, that is, the term of the lyrics, registered in the song phrase dictionary 340 is selected for use.

In the case where the selected word is registered in the song phrase dictionary 340, a song phonetic/prosodic symbol string corresponding to the selected word is read out from the song phrase dictionary 340, and stored in the work memory 360 together with a notation of the selected word (refer to steps S78 and S80 in FIG. 12B).

On the other hand, in the case where the selected word is an unregistered word which is not registered in the song phrase dictionary 340, the pronunciation of the unregistered word is read out from the pronunciation dictionary 306, and stored in the work memory 360 (refer to steps S79 and S80 in FIG. 12B).

The text pointer p is advanced by the length of the selected word, and analysis described above is repeated until the text pointer p comes to the end of a sentence of the input text, thereby dividing the input text into words from the head of the sentence to the end thereof (refer to the step S81 in FIG. 12B).

In case that analysis processing is not completed, the processing reverts to the step S73 whereas in case that the analysis processing is completed until the end of the input text, pronunciation of the respective words is read out from the work memory 360, and the input text is rendered into a word-string punctuated by every word, simultaneously reading out a song phonetic/prosodic symbol string. In this case, the sentence reading as ┌ [symbol] ┘ is punctuated by words consisting of ┌ [symbol] ┘.

Subsequently, in the text analyzer 302, a phonetic/prosodic symbol string is generated from the word-string by replacing the lyrics in the word-string with the song phonetic/prosodic symbol string while basing other words therein on pronunciation thereof, and stored in the work memory 360 (refer to steps S82 and S83 in FIG. 12B).

If the respective words of the input text are expressed in relation to the pronunciation of every word, the input text is divided into word strings of ┌ [symbol] (ka're)┘, ┌ [symbol] (wa)┘, ┌ [symbol] a4 ku a4 ra b2 sa a4 ku a4 ra b2)┘, ┌ [symbol] (to)┘, ┌ [symbol] (utai)┘ ┌ [symbol] (ma'shi)┘, and ┌ [symbol] (ta)┘. What is shown in round brackets is information on the respective words, registered in the dictionaries, representing pronunciation in the case of words in the pronunciation dictionary 306, and a song phonetic/prosodic symbol string in the case of words in the song phrase dictionary 340. By use of the information on the respective words of the word string, registered in the dictionaries, that is, the information in the round brackets, the text analyzer 302 generates a phonetic/prosodic symbol string of ┌ka' re wa, sa a4 ku a4 ra b2 sa a4 ku a4 ra b2 to, utaima' shita┘, and sends the same to the rule-based speech synthesizer 304.

The rule-based speech synthesizer 304 reads out the phonetic/prosodic symbol string of ┌ka' re wa, sa a4 ku a4 ra b2 sa a4 ku a4 ra b2 to, utaima' shita┘ from the work memory 360, starting in sequence from a symbol string corresponding to a syllable at the head of the phonetic/prosodic symbol string (refer to the step S84 in FIG. 13).

The rule-based speech synthesizer 304 determines whether or not a symbol string as read out is a song phonetic/prosodic symbol string, that is, a phonetic/prosodic symbol string corresponding to the lyrics (refer to the step S85 in FIG. 13). If it is determined as a result that the symbol string as read out is not the song phonetic/prosodic symbol string, access to the speech waveform memory 308 is made by the rule-based speech synthesizer 304, and speech element data corresponding to the relevant symbol string are searched for, which is continued until relevant speech element data are found (refer to steps S86 and S87 in FIG. 13).

Upon retrieval of the speech element data corresponding to the relevant symbol string, a synthesized speech waveform corresponding to respective speech element data is read out from the speech waveform memory 308, and stored in the work memory 360 (refer to steps 88 and S89 in FIG. 13).

In the case where synthesized speech waveforms corresponding to the preceding syllables have already been stored in the work memory 360, synthesized speech waveforms are coupled one after another (refer to the step S90 in FIG. 13).

In case that read out of synthesized speech waveforms for the whole sentence of the text is incomplete (refer to the step S91 in FIG. 13), a symbol string corresponding to the succeeding syllable is read out (refer to the step S92 in FIG. 13), and the processing reverts to the step S85.

By executing such processing as described above with respect to the symbol strings of ┌ [symbol] (ka' re)┘, and ┌ [symbol] (wa)┘, respectively, a synthesized speech waveform in a normal speech style is formed as for ┌ka' re wa┘. The synthesized speech waveform as formed is delivered to the rule-based speech synthesizer 304, and stored in the work memory 360.

Subsequently, with respect to the symbol strings of ┌sa a4 ku a4 ra b2 sa a4 ku a4 ra b2┘, read out is executed (refer to the step S92 in FIG. 13).

If it is determined that the phonetic/prosodic symbol string of ┌sa a4 ku a4 ra b2 sa a4 ku a4 ra b2┘ is a song phonetic/prosodic symbol string as a result of the determination on whether or not the symbol string as read out is the song phonetic/prosodic symbol string, which is made in the step S85, the song phonetic/prosodic symbol string is sent out to the song phonetic/prosodic symbol string processing unit 350 for analysis of the same (refer to the step S93 in FIG. 13).

In the song phonetic/prosodic symbol string processing unit 350, the song phonetic/prosodic symbol string of ┌sa a4 ku a4 ra b2 sa a4 ku a4 ra b2┘ is analyzed. In the processing unit 350, analysis is executed with respect to the respective symbol strings. For example, since ┌sa a4┘ has a syllable ┌sa┘ with a symbol ┌a4┘ attached thereto, a synthesized speech waveform is generated for the syllable as a singing voice, and a pitch and a duration of a sound thereof will be those as specified by ┌a4┘.

Based on the result of such analysis of the respective symbol strings, access to the speech waveform memory 308 is made by the rule-based speech synthesizer 304, and speech element data corresponding to the result of the analysis are searched for (refer to steps S94 and S95 in FIG. 13). As a result, a synthesized speech waveform of the singing voice is formed from speech element data corresponding to the respective symbols (refer to the step S96 in FIG. 13).

The synthesized speech waveform of the singing voice is delivered to the rule-based speech synthesizer 304, and stored in the work memory 360 (refer to the step S89 in FIG. 13). The rule-based speech synthesizer 304 couples the synthesized speech waveform of the singing voice as received with the synthesized speech waveform of ┌ka' re wa┘ (refer to the step S90 in FIG. 13).

Thereafter, processing from the above-described step S85 to the step S90 is executed in sequence with respect to the symbol strings of ┌to, utai ma'shi ta┘. As a result of such processing, a synthesized speech waveform in a normal speech style can be generated from speech element data of the speech waveform memory 308. The synthesized speech waveform is coupled with the synthesized speech waveform of ┌ka' re wa, sa a4 ku a4 ra b2 sa a4 ku a4 ra b2┘.

In this connection, in case that a plurality of song phonetic/prosodic symbol strings are interpolated in the phonetic/prosodic symbol strings, the same processing, that is, generation of a synthesized speech waveform for every singing voice, and coupling thereof with synthesized speech waveforms already generated, is executed at every spot of interpolation.

In case that none of the song phonetic/prosodic symbol strings is interpolated in the phonetic/prosodic symbol strings, the operation of the rule-based speech synthesizer 304 is the same as that in the case of the conventional system.

An example of synthesized speech waveforms obtained as a result of the processing described in the foregoing is as shown in FIG. 11.

In FIG. 11, portions of the text reading as ┌ [symbol] ┘, corresponding to ┌ [symbol] ┘ and ┌ [symbol] ┘, are outputted in the form of a synthesized speech waveform in the normal speech style while a portion thereof, corresponding to ┌ [symbol] ┘, represents the lyrics, and consequently, the portion corresponding to the lyrics is outputted in the form of a synthesized speech waveform of a singing voice. That is, the portion of the synthesized speech waveform, representing the singing voice of ┌ [symbol] ┘, is embedded between the portions of the synthesized speech waveform, in the normal speech style, for ┌ [symbol] ┘ and ┌ [symbol] ┘, respectively, before outputted to the speaker 330 (refer to the step S97 in FIG. 13).

Synthesized speech waveforms for the input text in whole, formed in this way, are outputted from the speaker 330.

With the use of the system 300 according to the invention, it is possible to cause song phrase portions of the input text to be actually sung so as to be heard by a listener, and consequently, a synthesized speech becomes more appealing to the listener as compared with a case wherein the input text in whole is read in the normal speech style only, preventing the listener from getting bored or tired of listening to the synthesized speech.

Fourth Embodiment

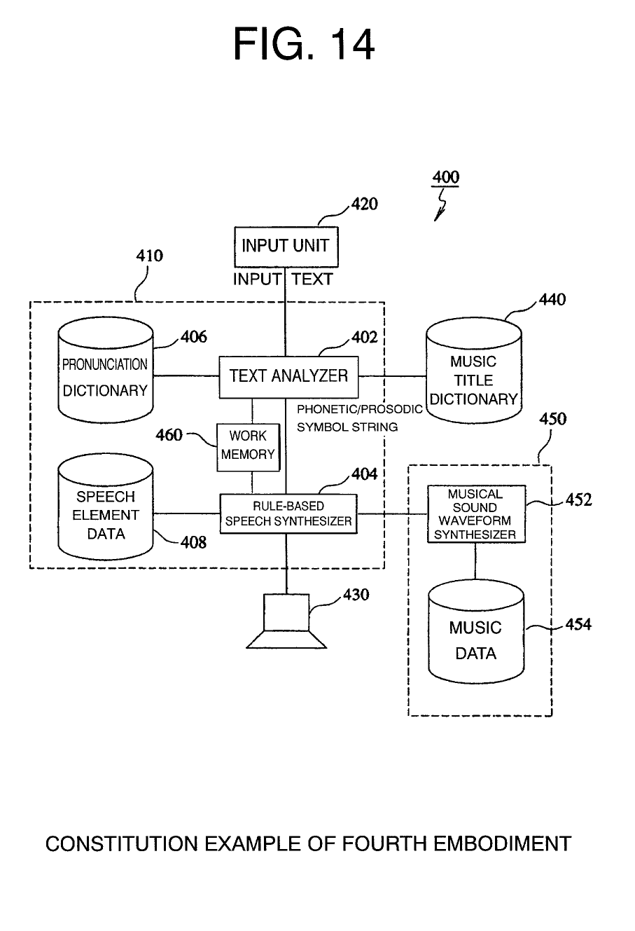

The fourth embodiment of a Japanese-text to speech conversion system according to the invention is described hereinafter with reference to FIGS. 14 to 17C. FIG. 14 is a block diagram showing the constitution of the system according to this embodiment by way of example. The system 400 as well comprises a conversion processing unit 410, an input unit 420, and a speaker 430 that are connected in the same way as in the constitution shown in FIG. 2.

Further, the conversion processing unit 410 comprises a text analyzer 402, a rule-based speech synthesizer 404, a pronunciation dictionary 406, a speech waveform memory 408 for storing speech element data, and a work memory 460 for fulfilling the same function as that of the work memory 160 previously described that are connected in the same way as in the constitution shown in FIG. 2.

In the case of the system 400, however, a music title dictionary 440 connected to the text analyzer 402, and a musical sound waveform generator 450 connected to the rule-based speech synthesizer 404 are installed.

Music titles are previously registered in the music title dictionary 440. That is, the music title dictionary 440 lists notations of music titles, and a music file name corresponding to the respective notations. Table 5 is a table showing the registered contents of the music title dictionary 440 by way of example. In Table 5, a notation of music titles such as ┌ [symbol] ┘ and ┌ [symbol] ┘, and so forth, respectively, and a music file name corresponding to the respective notations are shown by way of example.

TABLE 5

| NOTATION | MUSIC FILE NAME |
|---|---|
| [symbol] | AOGEBA. MID |
| [symbol] | KIMIGAYO. MID |
| [symbol] | NANATSU. MID |
| . . . | . . . |

The musical sound waveform generator 450 has a function of generating a musical sound waveform corresponding to respective music titles, and comprises a musical sound synthesizer 452, and a music dictionary 454 connected to the musical sound synthesizer 452.

Music data for use in performance, corresponding to respective music titles registered in the music title dictionary 440, are previously registered in the music dictionary 454. That is, an actual music file corresponding to the respective music titles listed in the music title dictionary 440 is stored in the music dictionary 454. The music files represent standardized music data in a form like MIDI (Musical Instrument Digital Interface). That is, MIDI is the communication protocol common throughout the world with the aim of communication among electronic musical instruments. For example, MIDI data for playing ┌ [symbol] ┘ are stored in ┌KIMIGAYO. MID┘. The musical sound synthesizer 452 has a function of converting music data (MIDI data) into musical sound waveforms and delivering the same to the rule-based speech synthesizer 404.

The text analyzer 402, and the rule-based speech synthesizer 404, composing the conversion processing unit 410, have a function, respectively, somewhat different from that 10 of those parts in the first to third embodiments, respectively, corresponding thereto. That is, the conversion processing unit 410 has a function of converting music titles in a text into speech waveforms. The conversion processing unit 410 has a function such that in the case where a music title in the text matches a registered music title as registered in the music title dictionary 440 upon collation of the former with the latter, a speech waveform obtained by converting music data corresponding to a relevant music title, registered in the musical sound waveform generator 450, into a musical sound waveform, is superimposed on a speech waveform of the text before outputted.

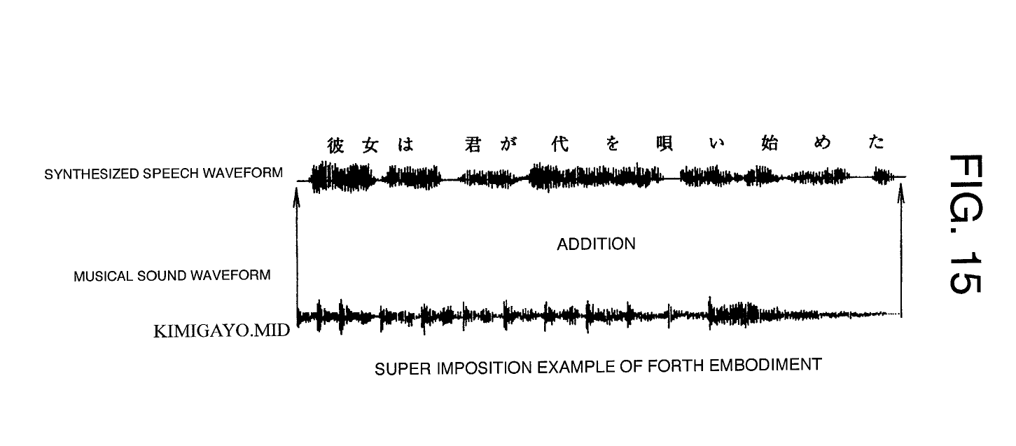

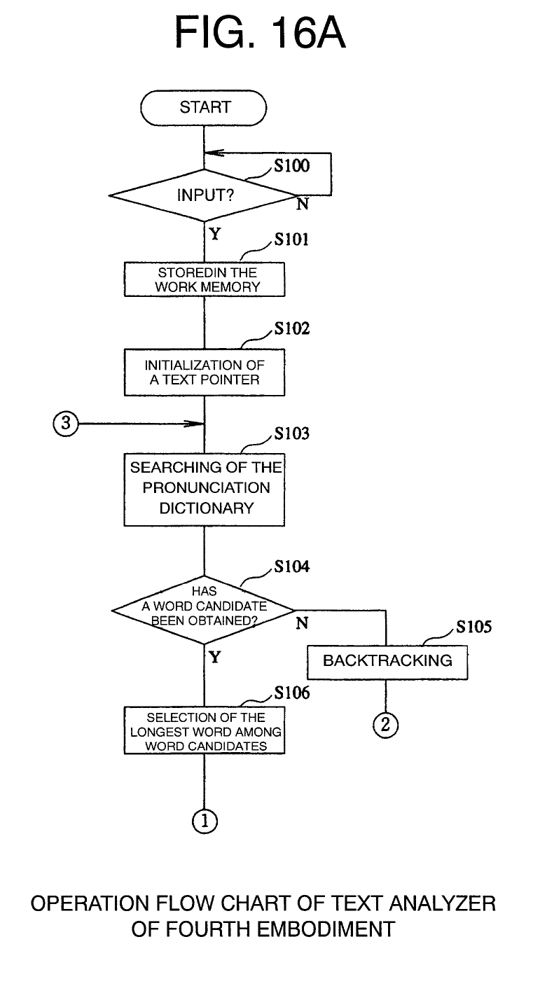

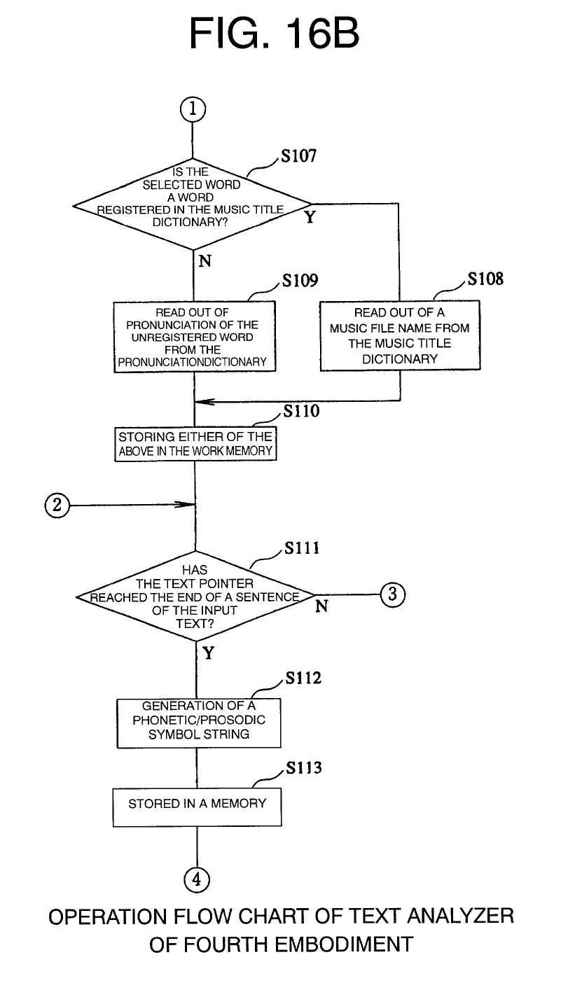

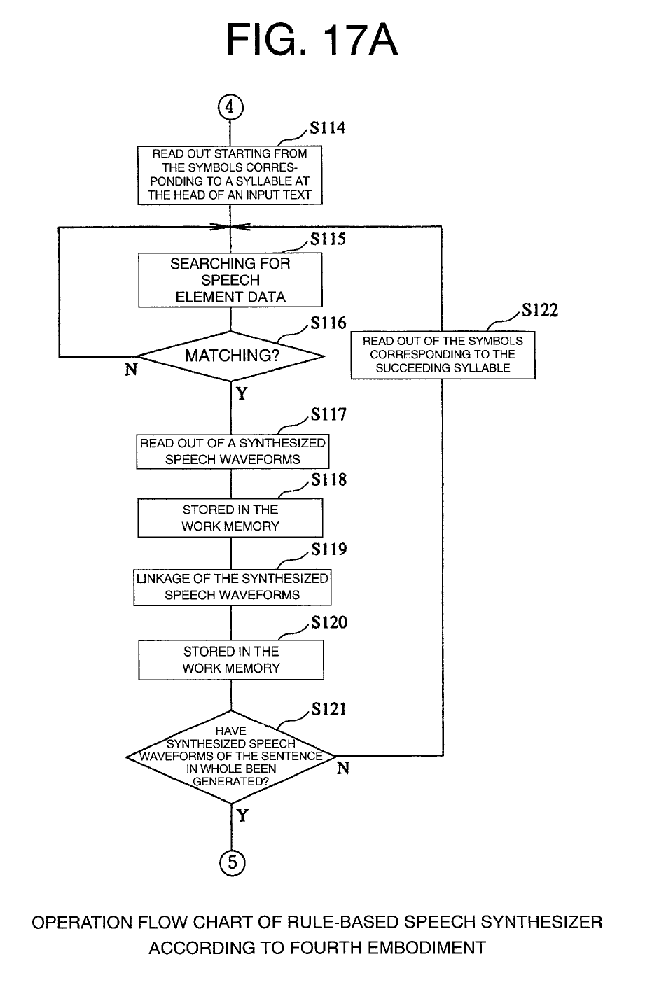

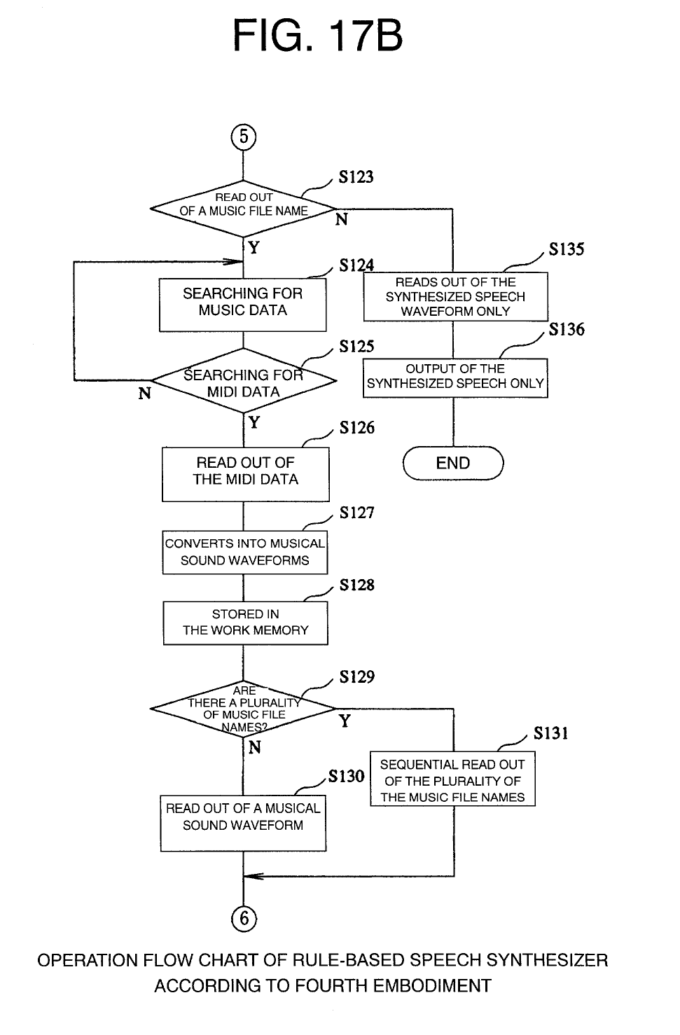

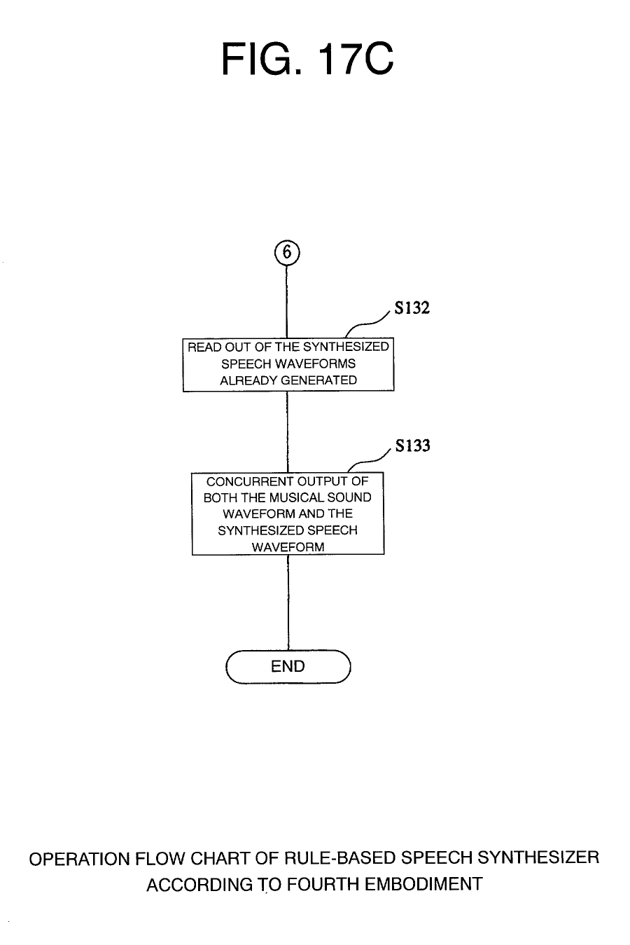

Now, operation of the Japanese-text to speech conversion system constituted as shown in FIG. 14 is described by citing a specific example. FIG. 15 is a view illustrating an example of superimposing a musical sound waveform on a synthesized speech waveform of the text in whole. The figure illustrates an example wherein the synthesized speech waveform of the text in whole and the musical sound waveform are outputted independently from each other, and concurrently. FIGS. 16A, 16B are operation flow charts of the text analyzer, and FIGS. 17A to 17C are operation flow charts of the rule-based speech synthesizer.

For example, a case is assumed wherein an input text in Japanese reads as ┌ [symbol] ┘. The input text is captured by the input unit 420 and inputted to the text analyzer 402, whereupon the input text is divided into words by the longest string-matching method in the same manner as described in the first embodiment. Processing from dividing the input text into words up to generation of a phonetic/prosodic symbol string is executed by taking the same steps as those described with reference to FIGS. 4A, 4B, and these steps are described hereinafter.

The text analyzer 402 determines whether or not an input text is inputted (refer to the step S100 in FIG. 16A). Upon verification of input, the input text is stored in the work memory 460 (refer to the step S101 in FIG. 16A).

Subsequently, the input text is divided into words by use of the longest string-matching method. Processing by the longest string-matching method is executed as follows:

A text pointer p is initialized by setting the text pointer p at the head of the input text to be analyzed (refer to the step S102 in FIG. 16A).

Subsequently, the pronunciation dictionary 406 is searched by the text analyzer 402 in order to examine whether or not there exists a word with a notation (dictionary entry) matching the string beginning at the text pointer p (the notation-matching method), and satisfying connection conditions (refer to the step S103 in FIG. 16A).

Whether or not there exist words satisfying the conditions, that is, whether or not word candidates can be obtained is searched (refer to the step S104 in FIG. 16A). In case the word candidates can not be found by such searching, the processing backtracks (refer to the step S105 in FIG. 16A), and proceeds to a step as described later on (refer to the step S111 in FIG. 16B).

Next, in case that the word candidates are obtained, the longest word is selected among the word candidates (refer to the step S106 in FIG. 16A). In this case, if there exist a plurality of the word candidates of the same length, adjunctive words are selected preferentially over self-existent words. Further, in case that there is only one word candidate, such a word is selected beyond question.

Subsequently, the music title dictionary 440 is searched in order to examine whether or not the selected word is a music title registered in the music title dictionary 440 (refer to the step S107 in FIG. 16B). Such searching is also executed against the music title dictionary 440 by the notation-matching method.

In the case where the selected word is registered in the music title dictionary 440, a music file name is read out from the music title dictionary 440, and stored in the work memory 460 together with a notation of the selected word (refer to steps S108 and S110 in FIG. 16B).

On the other hand, in the case where the selected word is an unregistered word which is not registered in the music title dictionary 440, the pronunciation of the unregistered word is read out from the pronunciation dictionary 406, and stored in the work memory 460 (refer to steps S109 and S110 in FIG. 16B).

The text pointer p is advanced by the length of the selected word, and analysis described above is repeated until the text pointer p comes to the end of a sentence of the input text, thereby dividing the input text into words from the head of the sentence to the end thereof (refer to the step S111 in FIG. 16B).

In case that analysis processing is not completed until the end of the input text, the processing reverts to the step S103 whereas in case that the analysis processing is completed, the pronunciation of the respective words is read out from the work memory 460, and the input text is rendered into a word-string punctuated by every word, simultaneously reading a music file name. In this case, the sentence reading as ┌ [symbol] ┘ is divided into words consisting of ┌ [symbol] ┘.

Subsequently, in the text analyzer 402, a phonetic/prosodic symbol string is generated based on the pronunciation of the respective words of the word string, and stored in the work memory 460 (refer to the step S113 in FIG. 16B).

If the respective words of the input text are expressed in relation to the pronunciation of every word, the input text is divided into word strings of ┌ [symbol] (ka' nojo)┘, ┌ [symbol] (wa)┘, ┌ [symbol] (kimigayo)┘, ┌ [symbol] (wo)┘, ┌ [symbol] (utai)┘, ┌ [symbol] (haji' me)┘, and ┌ [symbol] (ta)┘. What is shown in round brackets is information on the respective words, registered in the pronunciation dictionary 406, that is, pronunciation of the respective words.

Thus, by use of the information on the respective words of the word string, registered in the dictionary, that is, the information in the round brackets, the text analyzer 402 generates the phonetic/prosodic symbol string of ┌ka' nojo wa, kimigayo wo, utai haji' me ta┘.

Meanwhile, as described hereinbefore, the text analyzer 402 has examined in the step S107 whether or not the respective words in the word string are registered in the music title dictionary 440 by referring to the music title dictionary 440. In this embodiment, as the music title ┌ [symbol] (KIMIGAYO. MID)┘ (refer to Table 5) is registered therein, the music file name KIMIGAYO. MID: corresponding thereto is added to the head of the phonetic/prosodic symbol string, thereby converting the same into a phonetic/prosodic symbol string of ┌KIMIGAYO. MID: ka' nojo wa, kimigayo wo, utai haji' me ta┘, and storing the same in the work memory 460 (refer to steps S112 and S113 in FIG. 16B). Thereafter, the phonetic/prosodic symbol string with the music file name attached thereto is sent out to the rule-based speech synthesizer 404.

In case that a plurality of music titles registered in the music title dictionary 440 are included in the word string, all the music file names corresponding thereto are added to the head of the phonetic/prosodic symbol string as generated. In case that none of the music titles registered in the music title dictionary 440 is included in the word string, the phonetic/prosodic symbol string as previously generated is sent out to the rule-based speech synthesizer 404 with no add-ons.

On the basis of the phonetic/prosodic symbol string of ┌KIMIGAYO. MID: ka' nojo wa, kimigayo wo, utai haji' me ta┘ as received, the rule-based speech synthesizer 404 reads out relevant speech element data from the speech waveform memory 408 storing speech element data, thereby generating a synthesized speech waveform. The steps of processing in this case are described hereinafter.

First, read out is executed starting from a symbol string corresponding to a syllable at the head of the text. The rule-based speech synthesizer 404 determines whether or not a music file name is attached to the head of the phonetic/prosodic symbol string representing pronunciation. Since the music file name “KIMIGA YO. MID” is added to the head of the phonetic/prosodic symbol string in the case of this embodiment, a waveform of ┌ka' nojo wa, kimigayo wo, utai haji' me ta┘ is generated from speech element data of the speech waveform memory 408. Simultaneously, a musical sound waveform corresponding to the music file name “KIMIGAYO. MID” is sent from the musical sound waveform generator 450. The musical sound waveform and the previously-generated synthesized waveform of ┌ka' nojo wa, kimigayo wo, utai haji' me ta┘ are superimposed on each other from the beginning of the waveforms, and outputted.

In this case, if the time length of the waveform of “KIMIGAYO. MID” differs from that of the waveform of ┌ka' nojo wa, kimigayo wo, utai haji' me ta┘, the time length of a waveform after superimposed becomes equal to that of the longer one between the time length of the former and that of the latter. Incidentally, if the waveform of the former is shorter in length than that of the latter, the former can be repeated in succession until the length of the latter is reached before superimposed on the latter.

In the case where a plurality of music file names are added to the head of the phonetic/prosodic symbol string, the musical sound waveform generator 450 generates all musical sound waveforms corresponding thereto, and combines the musical sound waveforms in sequence before delivering the same to the rule-based speech synthesizer 404. In the case where none of the music file names is added to the head of the phonetic/prosodic symbol string, the operation of the rule-based speech synthesizer 404 is the same as that in the case of the conventional system.

The processing operation of the rule-based speech synthesizer 404 as described in the foregoing is executed as follows.

First, read out is executed starting from a symbol string corresponding to a syllable at the head of an input text (refer to the step S114 in FIG. 17A).

By such reading, the rule-based speech synthesizer 404 recognizes that a music file name is attached to the head of the symbol string. As a result, access to the speech waveform memory 408 is made by the rule-based speech synthesizer 404, and speech element data corresponding to respective symbols of the phonetic/prosodic symbol string following the music file name, representing pronunciation, are searched for (refer to steps S115 and S116 in FIG. 17A).

In case that there exist speech element data corresponding to the respective symbols, synthesized speech waveforms corresponding thereto are read out, and stored in the work memory 460 (refer to steps S117 and S118 in FIG. 17A).

The synthesized speech waveforms corresponding to the respective symbols are linked with each other in the order as read out, the result of which is stored in the work memory 460 (refer to steps S119 and S120 in FIG. 17A).

Subsequently, the rule-based speech synthesizer 404 determines whether or not synthesized speech waveforms of the sentence in whole as represented by the phonetic/prosodic symbol string of ┌ka' nojo wa, kimigayo wo, utai haji' me ta┘ are generated (refer to the step S121 in FIG. 17A). In case that it is determined as a result that the synthesized speech waveforms of the sentence in whole have not been generated as yet, a command to read out a symbol string corresponding to the succeeding syllable is issued (refer to the step S122 in FIG. 17A), and the processing reverts to the step S115.

In the case where the synthesized speech waveforms of the sentence in whole have already been generated, the rule-based speech synthesizer 404 reads out a music file name (refer to the step S123 in FIG. 17B). In the case of the embodiment described herein, since there exist the music file name, access to the music dictionary 454 of the musical sound waveform generator 450 is made, thereby searching for music data (refer to steps S124 and S125 in FIG. 17B).

In the case of this embodiment, the rule-based speech synthesizer 404 delivers the music file name “KIMIGAYO. MID” to the musical sound synthesizer 452. In response thereto, the musical sound synthesizer 452 executes searching of the music dictionary 454 for MIDI data on the music file “KIMIGAYO. MID”, thereby retrieving the MIDI data (refer to steps S125 and S126 in FIG. 17B).

The musical sound synthesizer 452 converts the MIDI data into a musical sound waveform, delivers the musical sound waveform to the rule-based speech synthesizer 404, and stores the same in the work memory 460 (refer to steps S127 and S128 in FIG. 17B).

Subsequently, upon completion of retrieval of the musical sound waveform corresponding to the music file name, the rule-based speech synthesizer 404 determines whether one music file name exists or a plurality of music file names exist (refer to the step S129 in FIG. 17B). In the case where only one music file name exists, a musical sound waveform corresponding thereto is read out from the work memory 460 (refer to the step S130 in FIG. 17B), and in the case where the plurality of the music file names exist, all musical sound waveforms corresponding thereto are read out in sequence from the work memory 460 (refer to the step S131 in FIG. 17B).

After read out of the musical sound waveforms (or upon read out of the musical sound waveforms), the synthesized speech waveform as already generated is read out from the work memory 460 (refer to the step S132 in FIG. 17C).

Upon completion of read out of both the musical sound waveforms and the synthesized speech waveform, both the musical sound waveforms and the synthesized speech waveform are concurrently outputted to the speaker 430 (refer to the step S133 in FIG. 17C).

Further, in case a music file name is not attached to the head of the phonetic/prosodic symbol string since a music title is not included in the input text, the processing proceeds from the step S107 to the step S109. Then, in the step S123, as there exists no music file name, the rule-based speech synthesizer 404 reads out the synthesized speech waveform only and outputs synthesized speech only (refer to steps S135 and S136 in FIG. 17B).

FIG. 15 shows an example of superimposition of the waveforms. This constitution example shows a state wherein the musical sound waveform of music under the title “ [symbol] ”, that is, a sound waveform of a playing music, is outputted at the same time the synthesized speech waveform of “ [symbol] ” is outputted. That is, during the identical time period from the starting point of the synthesized speech waveform to the endpoint thereof, the sound waveform of the playing music is outputted.

Superimposed speech waveforms for the input text in whole, thus generated, are outputted from the speaker 430.

With the use of the system 400 according to this embodiment of the invention, a music as referred to in the input text can be outputted as BGM in the form of a synthesized sound, and as a result, the synthesized speech outputted can be more appealing to a listener as compared with a case wherein the input text in whole is outputted in the synthesized speech only, thereby preventing the listener from getting bored or tired of listening.

Fifth Embodiment

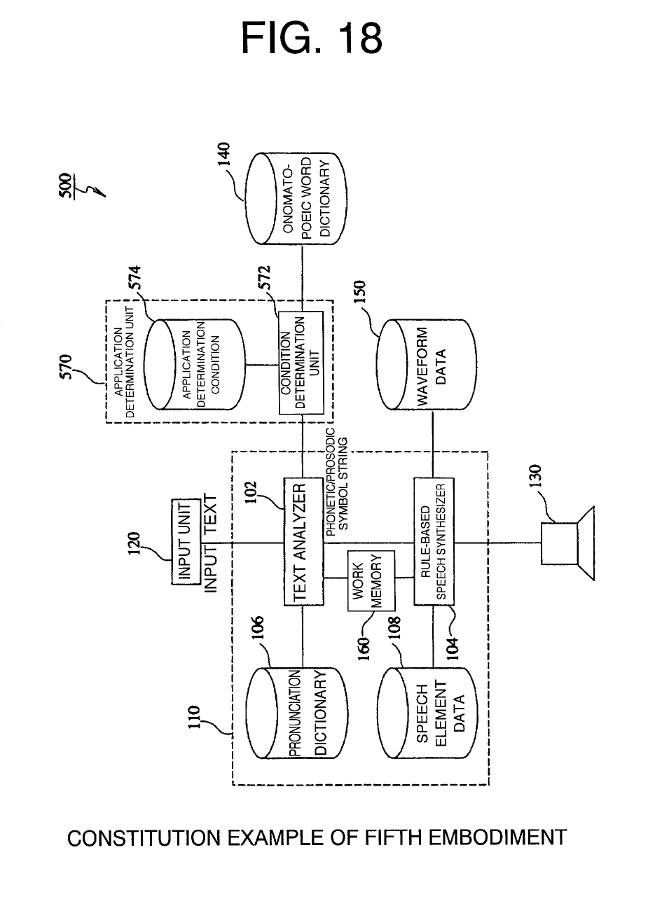

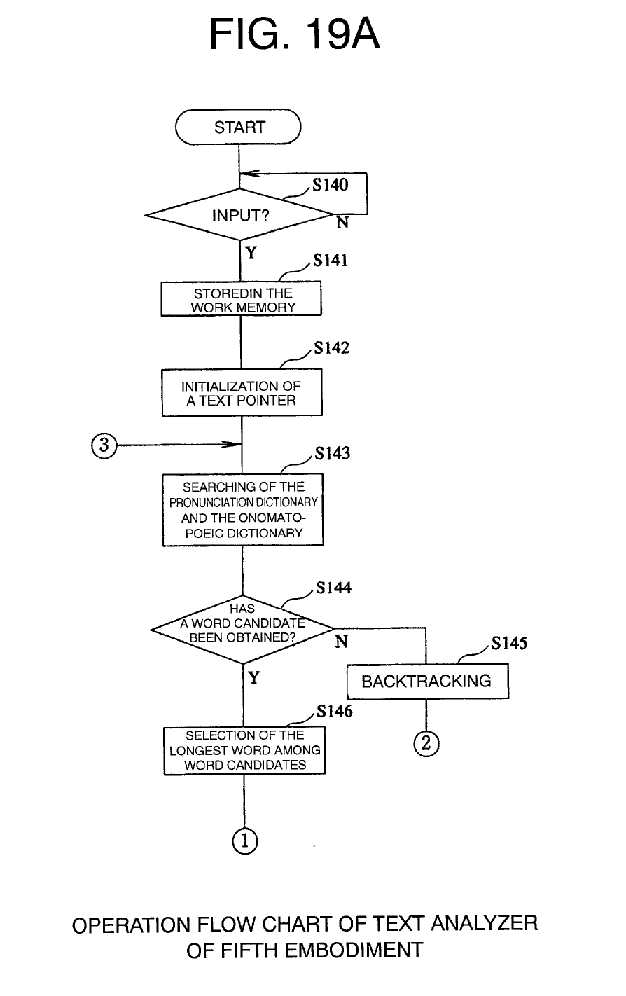

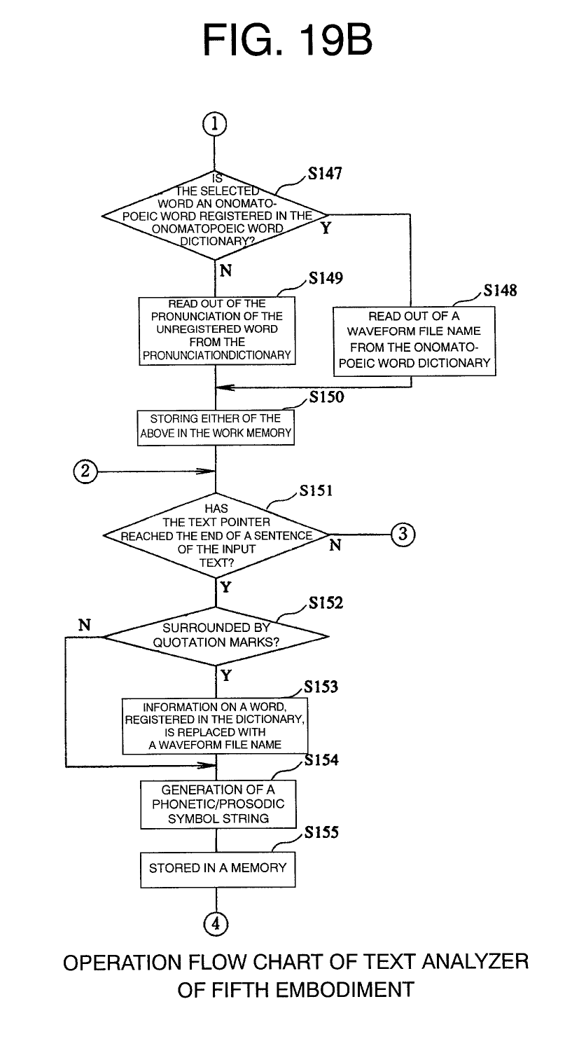

Subsequently, the constitution of the fifth embodiment of a Japanese-text to speech conversion system according to the invention is described hereinafter with reference to FIGS. 18 to 19B by way of example.

There are cases where terms in a Japanese text include a term surrounded by quotation marks. In particular, in the case of terms such as onomatopoeic words, lyrics, music titles, and so forth, there are cases where the terms are surrounded by quotation a marks, for example, ┌ ┘, ‘ ’, and “ ”, in order to stress the terms, or specific symbols such as [symbol] are attached before or after the terms. Accordingly, the fifth embodiment of the invention is constituted such that only a term surrounded by the quotation marks or only a term with a specific symbol attached preceding thereto or succeeding thereto is replaced with a speech waveform of an actually recorded sound in place of a synthesized speech waveform before outputted.

FIG. 18 is a block diagram showing the constitution of the fifth embodiment of the Japanese-text to speech conversion system according to the invention by way of example. The system 500 has the constitution wherein an application determination unit 570 is added to the constitution of the first embodiment previously described with reference to FIG. 2. More specifically, the system 500 differs in constitution from the system shown in FIG. 2 in that an application determination unit 570 is installed between the text analyzer 102 and the onomatopoeic word dictionary 140 as shown in FIG. 2. The system 500 according to the fifth embodiment has the same constitution, and executes the same operation, as described with reference to the first embodiment except for the constitution and the operation of the application determination unit 570. Accordingly, constituting elements of the system 500, corresponding to those of the first embodiment, are denoted by identical reference numerals, and detailed description thereof is omitted, describing points of difference only.

The application determination unit 570 determines whether or not a term in a text satisfies application conditions for collation of the term with terms registered in a phrase dictionary 140, that is, the onomatopoeic word dictionary 140 in the case of this example. Further, the application determination unit 570 has a function of reading out only a sound-related term matching a term satisfying the application conditions from the onomatopoeic word dictionary 140 to a conversion processing unit 110.

The application determination unit 570 comprises a condition determination unit 572 interconnecting a text analyzer 102 and the onomatopoeic word dictionary 140, and a rules dictionary 574 connected to the condition determination unit 572 for previously registering application determination conditions as the application conditions.

The application determination conditions describe conditions as to whether or not the onomatopoeic word dictionary 140 is to be used when onomatopoeic words registered in the phrase dictionary, that is, the onomatopoeic word dictionary 140, appear in an input text.

In Table 6, determination rules, that is, determination conditions, are listed such that the onomatopoeic word dictionary 140 is used only if an onomatopoeic word is surrounded by specific quotation marks. For example, ┌ ┘, ‘ ’, “ ”, or specific symbols such as [symbol] , and so forth are cited.

TABLE 6

a term surrounded by ┌┘
a term surrounded by “”
a term surrounded by ‘’ [symbol]
attached before a term [symbol]
attached after a term

Now, operation of the Japanese-text to speech conversion system constituted as shown in FIG. 18 is described by giving a specific example. FIGS. 19A, 19B are operation flow charts of the text analyzer.

For example, an input text in Japanese is assumed to read as ┌ [symbol] ┘. The input text is captured by an input unit 120 and inputted to a text analyzer 102.

The text analyzer 102 determines whether or not an input text is inputted (refer to the step S140 in FIG. 19A). Upon verification of input, the input text is stored in a work memory 160 (refer to the step S141 in FIG. 19A).

Subsequently, the input text is divided into words by use of the longest string-matching method. Processing by the longest string-matching method is executed as follows:

A text pointer p is initialized by setting the text pointer p at the head of the input text to be analyzed (refer to the step S142 in FIG. 19A).

Subsequently, a pronunciation dictionary 106 and an onomatopoeic word dictionary 140 are searched by the text analyzer 102 in order to examine whether or not there exists a word with a notation (dictionary entry) matching the string beginning at the text pointer p (the notation-matching method), and satisfying connection conditions (refer to the step S143 in FIG. 19A).

Subsequently, whether or not there exists a word satisfying the conditions in the pronunciation dictionary or the onomatopoeic word dictionary is searched (refer to the step S144 in FIG. 19A). In case that word candidates can not be found by such searching, the processing backtracks (refer to the step S145 in FIG. 19A), and proceeds to a step described later on (refer to the step S151 in FIG. 19B).

Next, in the case where the word candidates are obtained, the longest word is selected among the word candidates (refer to the step S146 in FIG. 19A). In this case, as with the case of the first embodiment, adjunctive words are preferably selected among word candidates of the same length, taking precedence over self-existent words if there exist a plurality of the word candidates of the same length while in case there exists only one word candidate, such a word is selected beyond question.

Subsequently, the onomatopoeic word dictionary 140 is searched for every selected word by sequential processing from the head of a sentence in order to examine whether or not the selected word is among the sound-related terms registered in the onomatopoeic word dictionary 140 (refer to the step S147 in FIG. 19B). Such searching is executed by the notation-matching method as well. In this case, the searching is executed via the condition determination unit 572 of the application determination unit 570.

In the case where the selected word is registered in the onomatopoeic word dictionary 140, a waveform file name is read out from the onomatopoeic word dictionary 140, and stored in the work memory 160 together with a notation of the selected word (refer to steps S148 and S150 in FIG. 19B).

On the other hand, in the case where the selected word is an unregistered word which is not registered in the onomatopoeic word dictionary 140, the pronunciation of the unregistered word is read out from the pronunciation dictionary 106, and stored in the work memory 160 (refer to steps S149 and S150 in FIG. 19B).

Then, the text pointer p is advanced by the length of the selected word, and analysis described above is repeated until the text pointer p comes to the end of a sentence of the input text, thereby dividing the input text into words from the head of the sentence to the end thereof (refer to the step S151 in FIG. 19B).

In case analysis processing is not completed until the end of the input text, the processing reverts to the step S143 whereas in case the analysis processing is completed, the pronunciation of the respective words is read out from the work memory 160, and the input text is rendered into a word-string punctuated by every word. For example, a sentence ┌ [symbol] ┘ is divided into words consisting of ┌ [symbol] ┘.

In the case of this embodiment, as a result of processing the sentence of the text reading as ┌ [symbol] ┘ up to the end thereof, there is obtained a word-string consisting of ┌ [symbol] (ne' ko)┘, ┌ [symbol] (ga)┘, ┌‘┘, ┌ [symbol] (nya'-)┘, ┌’┘, ┌(to)┘, ┌ [symbol] (nai)┘, and ┌ [symbol] (ta)┘. What is shown in round brackets is information on the words, registered in the pronunciation dictionary 106, that is, pronunciation of the respective words.

Subsequently, the text analyzer 102 conveys the word-string to the condition determination unit 572 of the application determination unit 570. Referring to the onomatopoeic word dictionary 140, the condition determination unit 572 examines whether or not words in the word-string are registered in the onomatopoeic word dictionary 140.

Thereupon, as ┌ [symbol] (“CAT. WAV”)┘ is registered, the condition determination unit 572 executes an application determination processing of the onomatopoeic word while referring to the rules dictionary 574 (refer to the step S152 in FIG. 19B). As shown in Table 6, the application determination conditions are specified in the rules dictionary 574. In the case of this embodiment, the onomat opoeic word ┌ [symbol] ┘ is surrounded by quotation marks ┌‘┘┌’┘ in the word-string, and consequently, the onomatopoeic word satisfies application determination rules, stating ┌surrounded by quotation marks ┌‘ ’┘. Accordingly, the condition determination unit 572 gives a notification to the text analyzer 102 for permission of application of the onomatopoeic word ┌ [symbol] (“CAT. WAV”)┘.

Upon receiving the notification, the text analyzer 102 substitutes a word ┌ [symbol] (“CAT. WAV”)┘ in the onomatopoeic word dictionary 140 for the word ┌ [symbol] (nya'-)┘ in the word-string, thereby changing the word-string into a word-string of ┌ [symbol] (ne' ko)┘, ┌ [symbol] (ga)┘, ┌ [symbol] (“CAT. WAV”)┘, ┌ [symbol] (to)┘, ┌ [symbol] (nai)┘, and ┌ [symbol] (ta)┘ (refer to the step S153 in FIG. 19B). At this point in time, the quotation marks ┌‘┘┌’┘ are deleted from the words-string as formed since the quotation marks have no information on pronunciation of words.

By use of the information on the respective words of the word string, registered in the dictionaries, that is, the information in the round brackets, the text analyzer 102 generates a phonetic/prosodic symbol string of ┌ne' ko ga, “CAT. WAV” to, nai ta┘, and stores the same in the work memory 160 (refer to the step S155 in FIG. 19B).

Meanwhile, a case where an input text reads as ┌ [symbol] ┘ is assumed. Referring to the pronunciation dictionary 106, the text analyzer 102 divides the input text into word-strings of ┌ [symbol] (inu')┘, ┌ [symbol] (ga)┘, ┌ [symbol] (wa' n wan)┘, ┌ [symbol] (ho' e)┘, and ┌ [symbol] (ta)┘ (refer to the steps S140 to S151).

The text analyzer 102 conveys the word-strings to the condition determination unit 572 of the application determination unit 570, and the condition determination unit 572 examines whether or not words in the word-strings are registered in the onomatopoeic word dictionary 140 by use of the longest string-matching method while referring to the onomatopoeic word dictionary 140. Thereupon, as ┌ [symbol] (“DOG.WAV”)┘ is registered therein, the condition determination unit 572 executes the application determination processing of the onomatopoeic word (refer to the step S152 in FIG. 19B). As the onomatopoeic word ┌ [symbol] ┘ is neither surrounded by the quotation marks ┌‘┘ ┌’┘ in the word-strings nor attached with a specific symbol such as [symbol] , and so forth, the onomatopoeic word does not satisfies any of the application determination conditions, specified in the rules dictionary 574. Accordingly, the condition determination unit 572 gives a notification to the text analyzer 102 for non-permission of application of the onomatopoeic word ┌z,9 (“DOG.WAV”)┘.

As a result, the text analyzer 102 does not change the word-string of ┌ [symbol] (inu')┘, ┌ [symbol] (ga)┘, ┌ [symbol] (wa' n wan)┘, ┌ [symbol] (ho' e)┘, ┌ [symbol] (ta)┘, and generates a phonetic/prosodic symbol string of ┌inu' ga, wa' n wan, ho' e ta┘ by use of information on the respective words of the word string, registered in the dictionaries, that is, information in the round brackets, storing the phonetic/prosodic symbol string in the work memory 160 (refer to the step S154 and the step S155 in FIG. 19B).

The phonetic/prosodic symbol string thus stored is read out from the work memory 160, sent out to a rule-based speech synthesizer 104, and processed in the same way as in the case of the first embodiment, so that waveforms of the input text in whole are outputted to a speaker 130.

Further, in case a plurality of onomatopoeic words registered in the onomatopoeic word dictionary 140 are included in the word-string, the condition determination unit 572 of the application determination unit 570 makes a determination on all the onomatopoeic words according to the application determination conditions specified in the rules dictionary 574, giving a notification to the text analyzer 102 as to which of the onomatopoeic words satisfies the determination conditions. Accordingly, it follows that waveform file names corresponding to only the onomatopoeic words meeting the determination conditions are interposed in the phonetic/prosodic symbol string.

Further, in the case where none of the onomatopoeic words registered in the onomatopoeic word dictionary 140 is included in the word string, application determination is not executed, and the phonetic/prosodic symbol string as generated from the unchanged word string is sent out to the rule-based speech synthesizer 104.

The advantageous effect obtained by use of the system 500 according to the invention is basically the same as that for the first embodiment. However, the system 500 is not constituted such that processing for outputting a portion of an input text, corresponding to an onomatopoeic word, in the form of the waveform of an actually recorded sound, is executed all the time. The system 500 is suitable for use in the case where a portion of the input text, corresponding to an onomatopoeic word, is outputted in the form of an actually recorded sound waveform only when certain conditions are satisfied. In contrast, for the case where such processing is to be executed all the time , the example as shown in the first embodiment is more suitable.

Sixth Embodiment

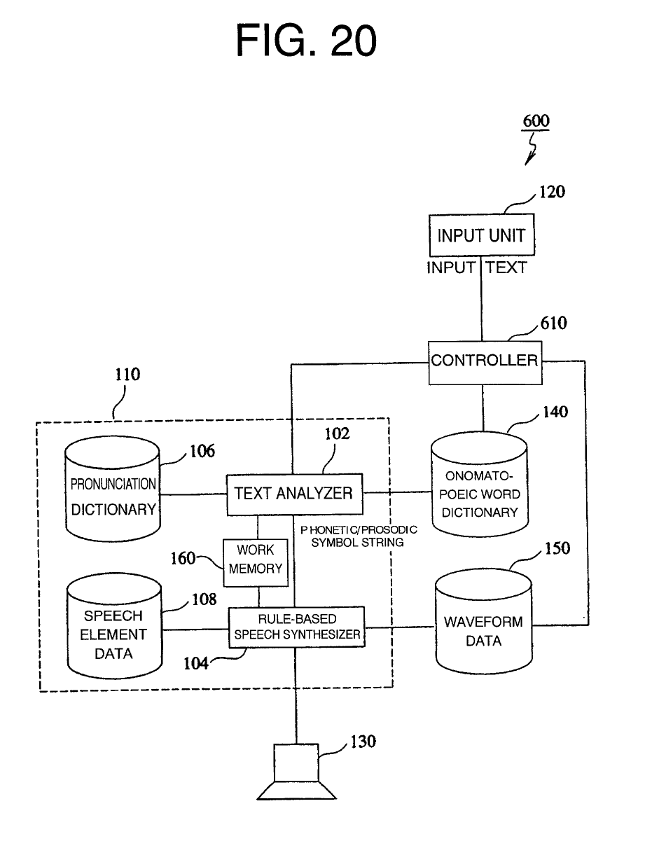

FIG. 20 is a block diagram showing the constitution of the sixth embodiment of the Japanese-text to speech conversion system according to the invention by way of example. The constitution of a system 600 is characterized in that a controller 610 is added to the constitution of the first embodiment described with reference to FIG. 2. The system 600 is capable of executing operation in two operation modes, that is, a normal mode, and an edit mode, by the agency of the controller 610.

When the system 600 operates in the normal mode, the controller 610 is connected to a text analyzer 102 only, so that exchange of data is not executed between the controller 610 and an onomatopoeic word dictionary 140 as well as a waveform dictionary 150.

On the other hand, when the system 600 operates in the edit mode, the controller 610 is connected to the onomatopoeic word dictionary 140 as well as the waveform dictionary 150, so that exchange of data is not executed between the controller 610 and the text analyzer 102.

That is, in the normal mode, the system 600 can execute the same operation as in the constitution of the first embodiment while, in the edit mode, the system 600 can execute editing of the onomatopoeic word dictionary 140 as well as the waveform dictionary 150. Such operation modes as described are designated by sending a command for designation of an operation mode from outside to the controller 610 via an input unit 120.

In the constitution of the sixth embodiment, detailed description of constituting element corresponding to those for the constitution of the first embodiment is omitted unless particular description is required.

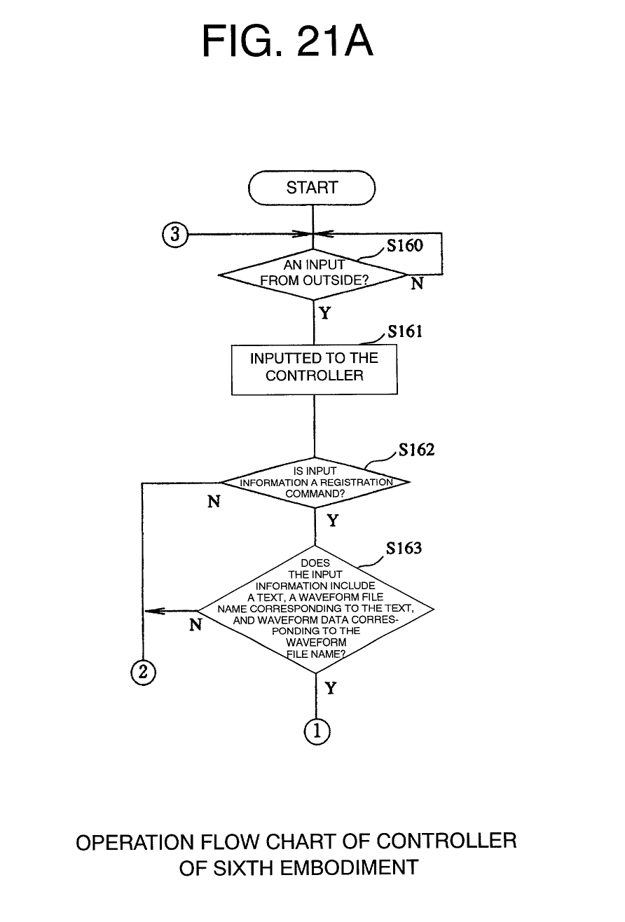

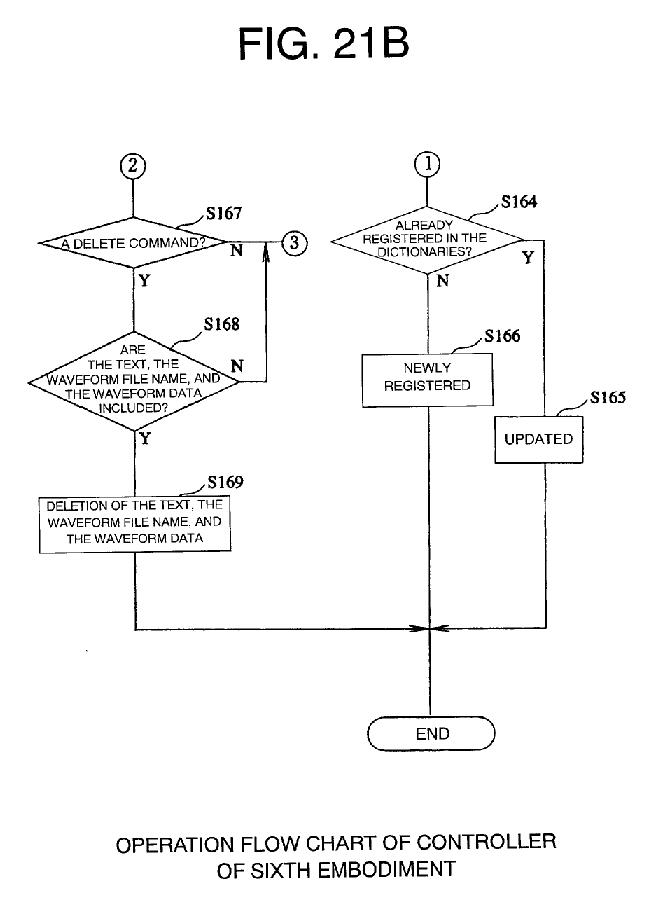

Next, referring to FIGS. 20 to 21B, operation of the Japanese-text to speech conversion system 600 is described hereinafter. FIGS. 21A, 21B are operation flow charts of the controller 610 in the constitution of the sixth embodiment.

First, a case where the system 600 operates in the edit mode by a command from outside is described hereinafter.

For example, a case is described wherein a user of the system 600 registers a waveform file “DUCK. WAV” of recorded quacking of a duck in the onomatopoeic word dictionary 140 as an onomatopoeic word such as ┌ [symbol] ┘. Following a registration command, input information such as a notation in a text, reading as ┌ [symbol] ┘, and the waveform file “DUCK. WAV” is inputted from outside to the controller 610 via the input unit 120. The controller 610 determines whether or not there is an input from outside, and receives the input information if there is one, storing the same in an internal memory thereof (refer to steps S160 and S161 in FIG. 21A).

If the input information is the registration command (refer to the step S162 in FIG. 21A), the controller 610 determines whether or not the input information from outside includes a text, a waveform file name corresponding to the text, and waveform data corresponding to the waveform file name (refer to the step S163 in FIG. 21A).

Subsequently, the controller 610 makes inquiries about whether or not information on an onomatopoeic word under a notation ┌ [symbol] ┘ and corresponding to the waveform file name “DUCK. WAV” within the input information has already been registered in the onomatopoeic word dictionary 140, and whether or not waveform data of the input information has already been registered in the waveform dictionary 150 (refer to the step S164 in FIG. 21B).

In case the input information is found already registered in the onomatopoeic word dictionary 140 as a result of such inquiries, the information on the onomatopoeic word under the notation ┌ [symbol] ┘ and corresponding to the waveform file name “DUCK. WAV” is updated, and similarly, in case the waveform data of the input information is found already registered in the waveform dictionary 150, the waveform data corresponding to the relevant waveform file name “DUCK. WAV” is updated (refer to the step S165 in FIG. 21B).

In case the input information described above to be registered in the onomatopoeic word dictionary 140 and the waveform dictionary 150, respectively, is found unregistered, the notation ┌ [symbol] ┘ and the waveform file name “DUCK. WAV” are newly registered in the onomatopoeic word dictionary 140, and waveform data obtained from an actually recorded sound, corresponding to the relevant waveform file name is newly registered in the waveform dictionary 150 (refer to the step S166 in FIG. 21B).

Meanwhile, for example, in the case where a user of the system 600 deletes an onomatopoeic word for ┌ [symbol] ┘ from the onomatopoeic word dictionary 140, there may be a case where a delete command, and subsequent thereto, input information on a portion of the text, ┌ [symbol] ┘, are inputted to the controller 610 via the steps S160 and S161, respectively.

In order to cope with such a case, if the input information is not the registration command, or the input information does not include information on the text, the waveform file name, and the waveform data, the controller 610 determines further whether or not the input information includes a delete command (refer to the steps S162 and S163 in FIG. 21A, and the step S167 in FIG. 21B).

If the input information includes the delete command, the controller 610 makes inquiries to the onomatopoeic word dictionary 140 and the waveform dictionary 150, respectively, about whether or not information as an object of deletion has already been registered in the respective dictionaries (refer to the step S168 in FIG. 21B). If it is found in these steps of processing that neither the delete command is included nor the information as the object of deletion is registered, the processing reverts to the step 160. If it is found in these steps of processing that the delete command is included and the information as the object of deletion is registered, the information described above, that is, the information on the notation in the text, the waveform file name, and the waveform data is deleted (refer to the step S169 in FIG. 21B).

More specifically, after confirming that the onomatopoeic word under the notation ┌ [symbol] ┘ and corresponding to the waveform file name “CAT. WAV” is registered in the onomatopoeic word dictionary 140, the controller 610 deletes the onomatopoeic word from the onomatopoeic word dictionary 140. Then, the waveform file “CAT. WAV” is also deleted from the waveform dictionary 150. In the case where an onomatopoeic word inputted following the delete command is not registered in the onomatopoeic word dictionary 140 from the outset, the processing is completed without taking any step.

Thus, in the edit mode, editing of the onomatopoeic word dictionary 140 and the waveform dictionary 150, respectively, can be executed.

In the normal mode, the controller 610 receives the input text, and sends out the same to the text analyzer 102. Since the processing thereafter is executed in the same way as with the first embodiment, description thereof is omitted.

In the final step, a synthesized speech waveform for the input text in whole is outputted from a conversion processing unit 110 to a speaker 130, so that a synthesized voice is outputted from the speaker 130.

Although the advantageous effect obtained by use of the system 600 according to the invention is basically the same as that for the first embodiment, the constitution example of the sixth embodiment is more suitable for a case where onomatopoeic words outputted in actually recorded sounds are added to, or deleted from the onomatopoeic word dictionary. That is, with this embodiment, it is possible to amend a phrase dictionary and waveform data corresponding thereto. On the other hand, the constitution of the first embodiment, shown by way of example, is more suitable for a case where neither addition nor deletion is made.

Examples of Modifications and Changes

It is to be understood that the scope of the invention is not limited in constitution to the above-described embodiments, and various modifications and changes may be made in the invention. By way of example, other embodiments of the invention will be described hereinafter.

(a) With the constitution of the second embodiment, if the waveform of the background sound is longer than the waveform of the input text, the former can be superimposed on the latter after gradually attenuating a sound volume of the former so as to become zero at the position matching the length of the latter instead of truncating the former to the length of the latter before superimposition.

(b) With the constitution of the fourth embodiment, if the musical sound waveform is longer than the waveform of the input text, the former can be superimposed on the latter after gradually attenuating a sound volume of the former so as to become zero at the position matching the length of the latter.

(c) With the constitution of the fifth embodiment, application of the onomatopoeic word dictionary 140 can also be executed by adding generic information such as ┌the subject┘ as registered information on respective words to the onomatopoeic word dictionary 140, and by providing a condition of ┌there is a match in the subject┘ as the application determination conditions of the rules dictionary 574. For example, in the case where an onomatopoeic word represented by ┌notation: [symbol] , waveform file: “LION. WAV”, the subject: [symbol] ┘ and an onomatopoeic word represented by ┌notation: [symbol] , waveform file: “BEAR. WAV”, the subject: [symbol] ┘ are registered in the onomatopoeic word dictionary 140, the condition determination unit 572 can be set such that, if the input text reads as ┌ [symbol] ┘, the latter meeting the condition of ┌there is a match in the subject┘, that is, the onomatopoeic word ┌ [symbol] ┘ of a bear is applied because the subject of the input text is ┌ [symbol] ┘, but the onomatopoeic word of a lion is not applied. That is, proper use of the waveform data can be made depending on the subject of the input text.

(d) The constitution of the fifth embodiment is based on that of the first embodiment, but can be similarly based on that of the second embodiment as well. That is, by adding a condition determination unit for determining application of the background sound dictionary, and a rules dictionary storing application determination conditions to the constitution of the second embodiment, the background sound dictionary 240 can also be rendered applicable only when the application determination conditions are met. Accordingly, instead of always using the waveform data corresponding to the phrase dictionary, use of the waveform data can be made only when certain application determination conditions are met.

(e) The constitution of the fifth embodiment is based on that of the first embodiment, but can be similarly based on that of the third embodiment as well. That is, by adding a condition determination unit for determining application of the song phrase dictionary, and a rules dictionary storing application determination conditions to the constitution of the third embodiment, the song phrase dictionary 340 can also be rendered applicable only when the application determination conditions are met. Accordingly, instead of always using the synthesized speech waveform of a singing voice, corresponding to the song phrase dictionary, use of the synthesized speech waveform of a singing voice can be made only when certain application determination conditions are met.

(f) The constitution of the fifth embodiment is based on that of the first embodiment, but can be similarly based on that of the fourth embodiment as well. That is, by adding a condition determination unit for determining application of the music title dictionary, and a rules dictionary storing application determination conditions to the constitution of the fourth embodiment, the music title dictionary 440 can also be rendered applicable only when the application determination conditions are met. Accordingly, instead of always using a playing music waveform, corresponding to the music title dictionary, use of a playing music waveform can be made only when certain application determination conditions are met.

(g) The constitution of the sixth embodiment is based on that of the first embodiment, but can be similarly based on that of the second embodiment as well. That is, by adding a controller to the constitution of the second embodiment, the sixth embodiment in the normal mode is enabled to operate in the same way as the second embodiment while the sixth embodiment in the edit mode is enabled to execute editing of the background sound dictionary 240 and waveform dictionary 250.

(h) The constitution of the sixth embodiment is based on that of the first embodiment, but can be similarly based on that of the third embodiment as well. That is, by adding a controller to the constitution of the third embodiment, the sixth embodiment in the normal mode is enabled to operate in the same way as the third embodiment while the sixth embodiment in the edit mode is enabled to execute editing of the song phrase dictionary 340. Accordingly, in this case, the registered contents of the song phrase dictionary can be changed.

(i) The constitution of the sixth embodiment is based on that of the first embodiment, but can be similarly based on that of the fourth embodiment as well. That is, by adding a controller to the constitution of the fourth embodiment, the sixth embodiment in the normal mode is enabled to operate in the same way as the fourth embodiment while the sixth embodiment in the edit mode is enabled to execute editing of the music title dictionary 440 and the music dictionary 454 storing music data. In this case, the registered contents of the music title dictionary and the music dictionary can be changed.

(j) The constitution of the sixth embodiment is based on that of the first embodiment, but can be similarly based on that of the fifth embodiment as well. That is, by adding a controller to the constitution of the fifth embodiment, the sixth embodiment in the normal mode is enabled to operate in the same way as the fifth embodiment while the sixth embodiment in the edit mode is enabled to execute editing of the onomatopoeic word dictionary 140, the waveform dictionary 150, and the rules dictionary 574 storing the application determination conditions. Thus, the determination conditions as to use of waveform data can be changed.

(k) Any of the first to sixth embodiments may be constituted by combining several thereof with each other.

What is claimed is:

1. A text-to-speech conversion system for converting a text into a speech waveform, and outputting the speech waveform, said system comprising;
a conversion processing unit for converting a text inputted from outside into a speech waveform;
a phrase dictionary for previously registering sound-related terms to be expressed as natural sound data of actually recorded sounds; and
a waveform dictionary for previously registering waveform data corresponding to the sound-related terms, obtained from the actually recorded sounds, wherein said conversion processing unit has a function such that as for a term in the text matching a sound-related term registered in said phrase dictionary upon collation of the former with the latter, waveform data corresponding to the relevant sound-related term matching the term in the text, registered in said waveform dictionary, is outputted as a speech waveform of the term.

2. A text-to-speech conversion system according to claim 1, further comprising an application determination unit for determining whether or not the term in the text satisfies application conditions for the collation thereof with said phrase dictionary, and reading out only the sound-related term matching the term satisfying the application conditions from said phrase dictionary to said conversion processing unit.

3. A text-to-speech conversion system according to claim 1, further comprising a controller for editing the registered contents of the sound-related terms registered in said phrase dictionary, and the waveform data registered in said waveform dictionary, respectively.

4. A text-to-speech conversion system according to claim 1, wherein said phrase dictionary is an onomatopoeic word dictionary for registering onomatopoeic words.

5. A text-to-speech conversion system according to claim 2, wherein said application conditions include a condition such that the term in the text is surrounded by quotation marks.

6. A text-to-speech conversion system according to claim 2, wherein said application conditions include a condition such that a specific symbol is provided before and/or after the term in the text.

7. A text-to-speech conversion system according to claim 2, wherein said application conditions include a condition such that in the case where the sound-related terms together with information on the subject thereof are registered in said phrase dictionary, there is a match between the information on the subject and the grammatical subject of the text.

8. A text-to-speech conversion system according to claim 2, further comprising application conditions change means capable of changing said application conditions.

9. A text-to-speech conversion system for converting a text into a speech waveform, and outputting the speech waveform, said system comprising;
a conversion processing unit for converting a text inputted from outside into a speech waveform;
a phrase dictionary for previously registering sound-related terms to be expressed as natural sound data of actually recorded sounds; and
a waveform dictionary for previously registering waveform data corresponding to the sound-related terms, obtained from the actually recorded sounds, wherein said conversion processing unit has a function such that in the case where there is a match between a term in the text and a sound-related terms registered in said phrase dictionary upon collation of the former with the latter, waveform data corresponding to the relevant sound-related term matching the term in the text, registered in said waveform dictionary, is superimposed on a speech waveform of the text before outputted.

10. A text-to-speech conversion system according to claim 9, further comprising an application determination unit for determining whether or not the term in the text satisfies application conditions for the collation thereof with said phrase dictionary, and reading out only the sound-related term matching the term satisfying the application conditions from said phrase dictionary to said conversion processing unit.

11. A text-to-speech conversion system according to claim 9, wherein said conversion processing unit has a function of adjusting the time length of the waveform data read out from said waveform dictionary.

12. A text-to-speech conversion system according to claim 11, wherein in case that the time length of the waveform data is longer than that of the speech waveform of the text, the time length is adjusted by truncating the relevant waveform data at the position where the speech waveform of the relevant text comes to the end.

13. A text-to-speech conversion system according to claim 11, wherein in case that the time length of the waveform data is longer than that of the speech waveform of the text, the time length is adjusted by gradually attenuating the sound volume of the relevant waveform data so as to become zero at the position where the speech waveform of the relevant text comes to the end.

14. A text-to-speech conversion system according to claim 11, wherein in case that the time length of the waveform data is shorter than that of the speech waveform of the text, the time length is adjusted by coupling together the relevant waveform data repeated in succession.

15. A text-to-speech conversion system according to claim 9, further comprising a controller for editing the registered contents of the sound-related terms registered in said phrase dictionary, and the waveform data registered in said waveform dictionary, respectively.

16. A text-to-speech conversion system according to claim 9, wherein said phrase dictionary is an background sound dictionary for registering background sounds.

17. A text-to-speech conversion system according to claim 10, wherein said application conditions include a condition such that the term in the text is surrounded by quotation marks.

18. A text-to-speech conversion system according to claim 10, wherein said application conditions include a condition such that a specific symbol is provided before and/or after the term in the text.

19. A text-to-speech conversion system according to claim 10, wherein said application conditions include a condition such that in the case where the sound-related terms together with information on the subject thereof are registered in said phrase dictionary, there is a match between the information on the subject and the grammatical subject of the text.

20. A text-to-speech conversion system according to claim 10, further comprising application conditions change means capable of changing said application conditions.

21. A text-to-speech conversion system for converting a text into a speech waveform, and outputting the speech waveform, said system comprising;
a conversion processing unit for converting a text containing lyrics, inputted from outside, into a speech waveform;
a song phrase dictionary for previously registering pairs of lyrics and song phonetic/prosodic symbol strings corresponding thereto; and
a song phonetic/prosodic symbol string processing unit for analyzing a song phonetic/prosodic symbol string in order to convert said song phonetic/prosodic symbol string into a synthesized speech waveform of a singing voice, wherein said conversion processing unit has a function such that as for lyrics in the text, matching lyrics registered in said song phrase dictionary upon collation of the former with the latter, a speech waveform of a singing voice, converted on the basis of the song phonetic/prosodic symbol string paired off with registered lyrics that have matched, registered in said song phrase dictionary, is outputted as a speech waveform of the relevant lyrics.

22. A text-to-speech conversion system according to claim 21, further comprising an application determination unit for determining whether or not the lyrics in the text satisfies application conditions for the collation thereof with said song phrase dictionary, and reading out the song phonetic/prosodic symbol string paired off with the registered lyrics matching the relevant lyrics satisfying the application conditions from said song phrase dictionary to said conversion processing unit.

23. A text-to-speech conversion system according to claim 21, further comprising a controller for editing the registered contents of the lyrics, and the song phonetic/prosodic symbol string, paired off with the registered lyrics, respectively.

24. A text-to-speech conversion system according to claim 22, wherein said application conditions include a condition such that the lyrics in the text is surrounded by quotation marks.

25. A text-to-speech conversion system according to claim 22, wherein said application conditions include a condition such that a specific symbol is provided before and/or after the lyrics in the text.

26. A text-to-speech conversion system according to claim 22, further comprising application conditions change means capable of changing said application conditions.

27. A text-to-speech conversion system for converting a text into a speech waveform, and outputting the speech waveform, said system comprising;
a conversion processing unit for converting a text containing a music title, inputted from outside, into a speech waveform;
a music title dictionary for previously registering music titles; and
a musical sound waveform generator for generating a musical sound waveform corresponding to the relevant music title, wherein said musical sound waveform generator comprises a music dictionary for previously registering music data for use in performance, corresponding to the music titles registered in said music title dictionary, and a musical sound synthesizer for converting the relevant music data for use in performance into a musical sound waveform of music, and said conversion processing unit has a function such that as for a music title in the text, matching a music title registered in said music title dictionary upon collation of the former with the latter, the musical sound waveform of music corresponding to the registered music title is superimposed on a speech waveform of the text before outputted.

28. A text-to-speech conversion system according to claim 27, further comprising an application determination unit for determining whether or not the music title in the text satisfies application conditions for the collation thereof with said music title dictionary, and reading out only the registered music title matching the relevant music title satisfying the application conditions from said music title dictionary to said conversion processing unit.

29. A text-to-speech conversion system according to claim 27, wherein said conversion processing unit has a function of adjusting the time length of the musical sound waveform sent from said musical sound synthesizer.

30. A text-to-speech conversion system according to claim 29, wherein in case that the waveform length, namely, the time length of the musical sound waveform differs from the waveform length of the speech waveform of the text, said time length is adjusted with the longer of both the waveform lengths.

31. A text-to-speech conversion system according to claim 29, wherein in case that the time length of the musical sound waveform is shorter than that of the speech waveform of the text, said time length is adjusted by coupling together relevant musical sound waveform data repeated in succession.

32. A text-to-speech conversion system according to claim 27, further comprising a controller for editing the contents of music titles registered in said music title dictionary, and the music data for use in performance registered in said music dictionary, respectively.

33. A text-to-speech conversion system according to claim 28, wherein said application conditions include a condition such that the music title in the text is surrounded by quotation marks.

34. A text-to-speech conversion system according to claim 28, wherein said application conditions include a condition such that a specific symbol is provided before and/or after the music title in the text.

35. A text-to-speech conversion system according to claim 28, further comprising application conditions change means capable of changing said application conditions.

36. A text-to-speech conversion system according to claim 1, wherein the sound-related terms registered in said phrase dictionary include a notation of the relevant sound-related term, and a waveform file name corresponding to the notation, while the waveform data registered in said waveform dictionary are natural sound data of actually recorded sounds, and stored as waveform files.

37. A text-to-speech conversion system according to claim 1, wherein the sound-related terms registered in said phrase dictionary include a notation of the relevant sound-related term, and a waveform file name corresponding to the notation, while the waveform data registered in said waveform dictionary are natural sound data of actually recorded sounds, and stored as waveform files, said conversion processing unit comprising;
an input unit to which the text is inputted;
a pronunciation dictionary for registering pronunciation of respective words;
a text analyzer connected to said input unit, said pronunciation dictionary, and said phrase dictionary, for generating a phonetic/prosodic symbol string of the text by using the waveform file name of the sound-related term registered in said phrase dictionary against a term registered in both said pronunciation dictionary and said phrase dictionary among terms in the text inputted from said input unit, and by using the pronunciation of the respective words registered in said pronunciation dictionary against other terms;
a speech waveform memory for storing speech element data; and
a rule-based speech synthesizer connected to said speech waveform memory, said waveform dictionary, and said text analyzer, for converting respective symbols except said waveform file name, in said phonetic/prosodic symbol string, into a speech waveform with the use of said speech element data while reading out waveform data corresponding to said waveform file name from said waveform dictionary, thereby outputting a synthesized waveform consisting of the speech waveform and the waveform data.

38. A text-to-speech conversion system according to claim 9, wherein the sound-related terms registered in said phrase dictionary include a notation of the relevant sound-related term, and a waveform file name corresponding to the notation, while the waveform data registered in said waveform dictionary are natural sound data of actually recorded sounds, and stored as waveform files.

39. A text-to-speech conversion system according to claim 10, wherein the sound-related terms registered in said phrase dictionary include a notation of the relevant sound-related term, and a waveform file name corresponding to the notation, while the waveform data registered in said waveform dictionary are natural sound data of actually recorded sounds, and stored as waveform files.

40. A text-to-speech conversion system according to claim 9, wherein the sound-related terms registered in said phrase dictionary include a notation of the relevant sound-related term, and a waveform file name corresponding to the notation, while the waveform data registered in said waveform dictionary are natural sound data of actually recorded sounds, and stored as waveform files, said conversion processing unit comprising;
an input unit to which the text is inputted;
a pronunciation dictionary for registering pronunciation of respective words;
a text analyzer connected to said input unit, said pronunciation dictionary, and said phrase dictionary, for generating a phonetic/prosodic symbol string of the text by using the waveform file name of the relevant sound-related term registered in said phrase dictionary against a term registered in both said pronunciation dictionary and said phrase dictionary among terms in the text inputted from said input unit, and by using the pronunciation of the respective words registered in said pronunciation dictionary against other terms;
a speech waveform memory for storing speech element data; and
a rule-based speech synthesizer connected to said speech waveform memory, said waveform dictionary, and said text analyzer, for converting respective symbols except said waveform file name, in said phonetic/prosodic symbol string, into a speech waveform with the use of said speech element data while reading out waveform data corresponding to said waveform file name from said waveform dictionary, thereby outputting the speech waveform and the waveform data concurrently.

41. A text-to-speech conversion system according to claim 10, wherein the sound-related terms registered in said phrase dictionary include a notation of the relevant sound-related term, and a waveform file name corresponding to the notation, while the waveform data registered in said waveform dictionary are natural sound data of actually recorded sounds, and stored as waveform files, said conversion processing unit comprising;
an input unit to which the text is inputted;
a pronunciation dictionary for registering pronunciation of respective words;
a text analyzer connected to said input unit, said pronunciation dictionary, and said phrase dictionary, for generating a phonetic/prosodic symbol string of the text by using the waveform file name of the relevant sound-related term registered in said phrase dictionary against a term registered in both said pronunciation dictionary and said phrase dictionary among terms in the text inputted from said input unit, and by using the pronunciation of the respective words registered in said pronunciation dictionary against other terms;
a speech waveform memory for storing speech element data; and
a rule-based speech synthesizer connected to said speech waveform memory, said waveform dictionary, and said text analyzer, for converting respective symbols except said waveform file name, in said phonetic/prosodic symbol string, into a speech waveform with the use of said speech element data while reading out waveform data corresponding to said waveform file name from said waveform dictionary, thereby outputting the speech waveform and the waveform data concurrently.

42. A text-to-speech conversion system according to claim 9, wherein said phrase dictionary is a background sound dictionary for registering a notation of respective background sounds, and a waveform file name corresponding to respective notations.

43. A text-to-speech conversion system according to claim 10, wherein said phrase dictionary is a background sound dictionary for registering a notation of respective background sounds, and a waveform file name corresponding to respective notations.

44. A text-to-speech conversion system according to claim 21, wherein said conversion processing unit comprises:
an input unit to which the text is inputted;
a pronunciation dictionary for registering pronunciation of respective words;
a text analyzer connected to said input unit, said pronunciation dictionary, and said phrase dictionary, for generating a phonetic/prosodic symbol string of the text by using said song phonetic/prosodic symbol string registered in said song phrase dictionary against the lyrics among terms in the text inputted from said input unit, and by using the pronunciation of the respective words registered in said pronunciation dictionary against other terms;
a speech waveform memory for storing speech element data; and
a rule-based speech synthesizer connected to said speech waveform memory, said song phonetic/prosodic symbol string processing unit, and said text analyzer, for converting respective symbols except said song phonetic/prosodic symbol string, in the phonetic/prosodic symbol string, into a speech waveform with the use of said speech element data while collaborating with said song phonetic/prosodic symbol string processing unit and said speech waveform memory for causing said song phonetic/prosodic symbol string processing unit to generate waveform data corresponding to said song phonetic/prosodic symbol string, thereby outputting a synthesized waveform consisting of the speech waveform and the waveform data.

45. A text-to-speech conversion system according to claim 27, wherein the music titles registered in said music title dictionary include the notation of the relevant music title, and the music file name corresponding to the notation, while the music data for use in performance, registered in said music dictionary, are stored as waveform files, said conversion processing unit comprising;
an input unit to which the text is inputted;
a pronunciation dictionary for registering pronunciation of respective words;
a text analyzer connected to said input unit, said pronunciation dictionary, and said phrase dictionary, for generating a phonetic/prosodic symbol string of the text by using the music file name against the relevant music title among terms in the text inputted from said input unit, and by using the pronunciation of the respective words registered in said pronunciation dictionary against all other terms;
a speech waveform memory for storing speech element data; and
a rule-based speech synthesizer connected to said speech waveform memory, said musical sound waveform generator, and said text analyzer, for converting respective symbols of the phonetic/prosodic symbol string into a speech waveform with the use of said speech element data while reading out the music data for use in performance, corresponding to said music file name from said musical sound waveform generator, thereby concurrently outputting the speech waveform and the music data for use in performance.

46. A text-to-speech conversion system according to claim 2, wherein said application determination unit comprises a rules dictionary for storing the application conditions, and a condition determination unit for determining whether or not said phrase dictionary is to be applied, interconnecting said conversion processing unit and said phrase dictionary.

47. A text-to-speech conversion system according to claim 10, wherein said application determination unit comprises a rules dictionary for storing the application conditions, and a condition determination unit for determining whether or not said phrase dictionary is to be applied, interconnecting said conversion processing unit and said phrase dictionary.

48. A text-to-speech conversion system according to claim 22, wherein said application determination unit comprises a rules dictionary for storing the application conditions, and a condition determination unit for determining whether or not said phrase dictionary is to be applied, interconnecting said conversion processing unit and said phrase dictionary.

49. A text-to-speech conversion system according to claim 28, wherein said application determination unit comprises a rules dictionary for storing the application conditions, and a condition determination unit for determining whether or not said music title dictionary is to be applied, interconnecting said conversion processing unit and said music title dictionary.
